(19) United States
(12) Patent Application Publication
(10) Pub. No.: US 2026/0110547 A1
(43) Pub. Date: Apr. 23, 2026

(54) METHOD AND SYSTEM FOR VEHICLE ROUTE DETERMINATION BASED ON MOTION DATA

(71) Applicant: Cambridge Mobile Telematics Inc., Cambridge, MA (US)

(72) Inventors: Fengdi Guo, Quincy, MA (US); Harrison Kitchen, Braintree, MA (US); Matthew Evan Lewin, Lexington, MA (US); Yuting Qi, Lexington, MA (US); William Abildgaard, JR., Waltham, MA (US); Ankit Singhania, Somerville, MA (US); Edward Gelberg, Ashland, MA (US)

(73) Assignee: Cambridge Mobile Telematics Inc., Cambridge, MA (US)

(21) Appl. No.: 19/364,655

(22) Filed: Oct. 21, 2025

Related U.S. Application Data
(60) Provisional application No. 63/710,491, filed on Oct. 22, 2024.

(51) Int. Cl. G01C 21/36; G01S 19/49

(52) U.S. Cl. CPC G01C 21/3676; G01S 19/49

(57) ABSTRACT

Methods and systems for reconstructing a route traveled by a vehicle using motion sensor data are provided. In some embodiments, a method comprises receiving motion measurements from a plurality of sensors in a vehicle during a drive. An estimated sequence of turns and distances traveled before and after each turn is extracted from the motion measurements. A start location and an end location of the drive are determined. Candidate routes between the start and end locations are selected from historical routes, each comprising a sequence of turns and distances along road segments within a road network. The candidate routes are compared with the estimated sequence to determine mismatch scores. Based on the mismatch scores, the route traveled by the vehicle is identified. An interactive graphical user interface on a mobile device receives a request to display the drive on a map and displays the identified route in response.

### CROSS-REFERENCES TO RELATED APPLICATIONS

This application claims priority to U.S. Provisional Patent Application No. 63/710,491, filed on Oct. 22, 2024, entitled “Method and System for Vehicle Route Determination Based On Motion Data,” the disclosure of which is hereby incorporated by reference in its entirety for all purposes

### BACKGROUND

Unless otherwise indicated herein, the materials described in this section are not prior art to the claims in this application and are not admitted to be prior art by inclusion in this section.

A mobile device typically includes a Global Positioning System (GPS) receiver. The positioning of the mobile device, as well as the positioning of a carrier of the mobile device (a person, a vehicle, etc.), can be performed using GPS data. A history of locations of the mobile device, as well as historical routes undertaken by the vehicle that carries the mobile device, can also be determined based on past GPS data. The historical routes can be determined for various purposes, such as determining past driving behaviors of a driver of the vehicle during a trip or determining past driving events (e.g., vehicle crashes) that occurred in the trip.

While past GPS data allow determination of a history of locations and historical routes undertaken by the vehicle, the GPS data can become unavailable within certain route segments(s) of the trip. The GPS data can become unavailable due to various reasons such as, latency in acquiring and/or processing GPS signals for location determination, poor GPS signal reception, etc. If GPS data is relied upon to determine the locations of the vehicles, it may become difficult to determine certain historical routes undertaken the vehicle where GPS data is unavailable.

### SUMMARY

Embodiments of the present invention generally relate to vehicle route reconstruction, and more particularly, to reconstructing routes taken by a vehicle based on motion sensor data, historical route information, and, where available, Global Navigation Satellite System (GNSS) data.

In some embodiments, a method is provided for reconstructing a route taken by a vehicle. The method includes collecting, by a mobile device disposed in a vehicle during a first drive, GNSS data indicating a plurality of locations of the mobile device during the first drive. The method further includes analyzing the GNSS data, by a route detection server system, to identify a first start location and a first end location of the first drive. The method includes comparing the plurality of locations from the GNSS data with known locations of road segments within a road network from map data representing the road network to determine an actual route taken within the road network. In some embodiments, the actual route comprises a sequence of one or more turns separated by distances traveled along a road segment within the road network before and after each of the one or more turns.

The method also includes storing the actual route, by the route detection server system, in a historical routes datastore with a plurality of historical routes detected from past GNSS data collected by the mobile device. The method includes receiving, by the route detection server system, a collection of motion measurements collected by a plurality of motion sensors disposed in the vehicle during a subsequent drive for which accurate GNSS data from the mobile device is unavailable. The method includes analyzing the collection of motion measurements, by the route detection server system, to identify an estimated sequence of one or more complete turns made by the vehicle during the subsequent drive and one or more distances traveled by the vehicle before and after each of the one or more turns.

The method includes determining, by the route detection server system, a subsequent start location of the subsequent drive based on a first location of the mobile device after a trip immediately preceding the subsequent trip and before the subsequent trip began. The method further includes determining, by the route detection server system, a subsequent end location of the subsequent drive based on a second location of the mobile device after the subsequent drive and before a next drive. The method includes determining, by the route detection server system, a first distance between the first start location and the subsequent start location, a second distance between the first end location and the subsequent end location, or both the first distance and the second distance. The method includes determining, by the route detection server system, that the first distance, the second distance, or both, are less than or equal to a predefined distance threshold.

In some embodiments, the method includes identifying the actual route as a candidate route for the subsequent drive from the plurality of historical routes in response to determining that the first distance, the second distance, or both, are less than or equal to a predefined distance threshold. The method further includes comparing, by the route detection server system, the sequence of one or more turns and distances within the road network from the actual route with the estimated sequence of one or more complete turns and distances during the subsequent drive to determine a mismatch score between the actual route and the estimated sequence. The method includes determining, by the route detection server system, that the vehicle traveled along the actual route during the subsequent drive based on the mismatch score.

The method also includes receiving, by the route detection server system, via an interactive graphical user interface (GUI) presented on a display of the mobile device, a request to display the subsequent drive on a map. The method includes causing, by the route detection server system, the interactive GUI to display the actual route on the map in response to the request.

In some embodiments, a method is provided that includes receiving a collection of motion measurements collected by a plurality of motion sensors disposed in a vehicle during a drive. The method includes extracting, from the collection of motion measurements, an estimated sequence of one or more turns made by the vehicle during the drive and one or more distances traveled by the vehicle before and after each of the one or more complete turns. The method includes determining a start location and an end location of the drive. The method includes selecting one or more candidate routes between the start location and the end location from a plurality of historical routes. In some embodiments, each of the plurality of historical routes comprises a sequence of one or more turns separated by distances traveled along a road segment within a road network before and after each of the one or more turns.

The method further includes comparing the sequence of one or more turns and distances within the road network from each of the one or more candidate routes with the estimated sequence of one or more turns and distances traveled by the vehicle during the drive to determine respective mismatch scores for each of the one or more candidate routes. The method includes determining, based on the respective mismatch scores for each of the one or more candidate routes, that the vehicle traveled along a first route of the one or more candidate routes during the drive. The method further includes receiving, via an interactive graphical user interface presented on a display of a mobile device, a request to display the drive on a map. The method includes causing the interactive GUI to display the first route on the map in response to the request.

In some embodiments, at least one of the plurality of historical routes is derived from GNSS data collected by a GNSS enabled computing device during a first drive. The method may further include receiving the GNSS data from the GNSS enabled computing device, wherein the GNSS data indicates a plurality of locations of the computing device during the first drive. The method may include analyzing the GNSS data to identify a first start location and a first end location of the first drive. The method may further include comparing the plurality of locations from the GNSS data with known locations of road segments within the road network from map data representing the road network to determine an actual route taken within the road network during the first drive, and storing the actual route in a historical routes datastore.

In some embodiments, the method may further comprise receiving GNSS data collected by a GNSS enabled computing device disposed in the vehicle during a previous drive that occurred directly before the drive, and determining a most recent location of the GNSS enabled computing device leading up to a start time of the drive from the GNSS data. In such embodiments, the start location of the drive is determined based on the most recent location of the GNSS enabled computing device. In some embodiments, the method may further comprise receiving GNSS data collected by a GNSS enabled computing device disposed in the vehicle during a subsequent drive that occurred directly after the drive, and determining an earliest location of the GNSS enabled computing device after an end time of the drive from the GNSS data. In such embodiments, the end location of the drive is determined based on the earliest location of the GNSS enabled computing device.

In some embodiments, a candidate route is selected as one of the one or more historical routes from the plurality of historical routes in response to determining that a first distance between the start location of the drive and a first location along the candidate route is less than a predefined threshold distance, and determining that a second distance between the end location of the drive and a second location along the candidate route is less than the predefined threshold distance. In some embodiments, the starting location of the candidate route is selected as the first location and the ending location of the candidate route is selected as the second location. In some embodiments, the ending location of the candidate route is selected as the first location and the starting location of the candidate route is selected as the second location, and the method further comprises inverting the sequence of one or more turns and distances within the road network of the candidate route for comparison with the estimated sequence of one or more turns and distances traveled by the vehicle during the drive. In some embodiments, the first location, the second location, or both, are intermediate locations along the candidate route between the starting location and the ending location of the candidate route. The method may further comprise removing, from the candidate route, turns and distances from the sequence of one or more turns and distances within the road network before the first location, after the second location, or both, for comparison with the estimated sequence of one or more turns and distances traveled by the vehicle during the drive.

In some embodiments, the mismatch score for each of the one or more candidate routes is determined based on a sum of squared differences between corresponding distances traveled along segments of the estimated sequence and each candidate route, and a count of unmatched or extra turns. In some embodiments, the collection of motion measurements comprises a subset of accelerometer measurements collected by an accelerometer of the plurality of motion sensors. The method may further comprise determining rates of course change with respect to time based on the subset of accelerometer measurements, wherein the one or more turns are extracted based on comparing the rates of course change against a threshold.

In some embodiments, the method may further comprise determining that a driving event involving the vehicle occurred at a first time during the drive based on the collection of motion measurements. The method may further comprise determining an estimated location of the driving event in relation to the estimated sequence of one or more turns and distances traveled by the vehicle during the drive. The method may further comprise identifying a first location along the first route that corresponds to the estimated location of the driving event, and causing the interactive GUI to display, at the first location on the map, an indication of the detected driving event.

In some embodiments, the collection of motion measurements are received from the plurality of motion sensors by a GNSS enabled computing device, and the start location and the end location of the drive are determined from GNSS data collected by the GNSS enabled computing device. In some embodiments, the plurality of motion sensors are part of a sensing device installed in the vehicle.

In some embodiments, a system is provided comprising one or more sensors configured to measure movements of the one or more sensors while the one or more sensors are disposed in a vehicle during a drive, and an electronic device comprising one or more processors and a memory storing a set of instructions. The one or more processors are configured to execute the set of instructions to receive electronic signals from the one or more sensors, the electronic signals indicating the movements measured by the one or more sensors during the drive. The processors are further configured to extract, from the movements, an estimated sequence of one or more turns made by the vehicle during the drive and one or more distances traveled by the vehicle before and after each of the one or more complete turns. The processors are further configured to determine a start location and an end location of the drive, select one or more candidate routes between the start location and the end location from a plurality of historical routes, and compare the sequence of one or more turns and distances within the road network from each of the one or more candidate routes with the estimated sequence of one or more turns and distances traveled by the vehicle during the drive to determine respective mismatch scores for each candidate route. The processors are further configured to determine, based on the respective mismatch scores for each of the candidate routes, that the vehicle traveled along a first route of the candidate routes during the drive. The processors are further configured to receive, via an interactive graphical user interface presented on a display of a mobile device, a request to display the drive on a map, and to cause the interactive GUI to display the first route on the map in response to the request.

In some embodiments, at least one of the plurality of historical routes is derived from GNSS data collected by a GNSS enabled computing device during a first drive. The processors may be further configured to receive the GNSS data from the GNSS enabled computing device, analyze the GNSS data to identify a first start location and a first end location of the first drive, compare the plurality of locations from the GNSS data with known locations of road segments within the road network from map data representing the road network to determine an actual route taken within the road network during the first drive, and store the actual route in a historical routes datastore.

In some embodiments, the processors are further configured to receive GNSS data collected by a GNSS enabled computing device disposed in the vehicle during a previous drive that occurred directly before the drive, and determine a most recent location of the GNSS enabled computing device leading up to a start time of the drive from the GNSS data, wherein the start location of the drive is determined based on the most recent location of the GNSS enabled computing device. In some embodiments, the processors are further configured to receive GNSS data collected by a GNSS enabled computing device disposed in the vehicle during a subsequent drive that occurred directly after the drive, and determine an earliest location of the GNSS enabled computing device after an end time of the drive from the GNSS data, wherein the end location of the drive is determined based on the earliest location of the GNSS enabled computing device.

In some embodiments, a candidate route is selected as one of the historical routes from the plurality of historical routes in response to determining that a first distance between the start location of the drive and a first location along the candidate route is less than a predefined threshold distance, and determining that a second distance between the end location of the drive and a second location along the candidate route is less than the predefined threshold distance. In some embodiments, the processors are further configured to determine that a driving event involving the vehicle occurred at a first time during the drive based on the electronic signals from the sensors, determine an estimated location of the driving event in relation to the estimated sequence of turns and distances traveled by the vehicle during the drive, identify a first location along the first route that corresponds to the estimated location of the driving event, and cause the interactive GUI to display, at the first location on the map, an indication of the detected driving event.

### BRIEF DESCRIPTION OF THE DRAWINGS

Aspects and features of the various embodiments will be more apparent by describing examples with reference to the accompanying drawings, in which:

FIG. 1 is a block simplified diagram illustrating an example of a system for collecting driving data according to some aspects of the present disclosure.

FIG. 2 is a simplified block diagram illustrating example of another system for collecting driving data according to some aspects of the present disclosure.

FIG. 3A and FIG. 3B illustrate an example application for a missing route determination engine of FIG. 2 according to some aspects of the present disclosure.

FIG. 4 illustrates an example of internal components of a missing route determination engine, according to some aspects of the present disclosure.

FIG. 5 illustrates an example method for determining the start time of a trip, according to some aspects of the present disclosure.

FIG. 6A, FIG. 6B, FIG. 6C, and FIG. 6D illustrate example operations of missing route determination engine of FIG. 4, according to some aspects of the present disclosure.

FIG. 7A, FIG. 7B, FIG. 7C, and FIG. 7D illustrate example operations of missing route determination engine of FIG. 4, according to some aspects of the present disclosure.

FIG. 8A and FIG. 8B illustrate example applications of missing route determination engine of FIG. 4, according to some aspects of the present disclosure.

FIG. 9 illustrates an example of a method of route determination based on motion data, according to some aspects of the present disclosure.

FIG. 10 illustrates an example of a method of route determination based on cached data, according to some aspects of the present disclosure.

FIG. 11 illustrates an example of a method of route determination based on motion data, according to some aspects of the present disclosure.

### DETAILED DESCRIPTION OF SPECIFIC EMBODIMENTS

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### Example Systems

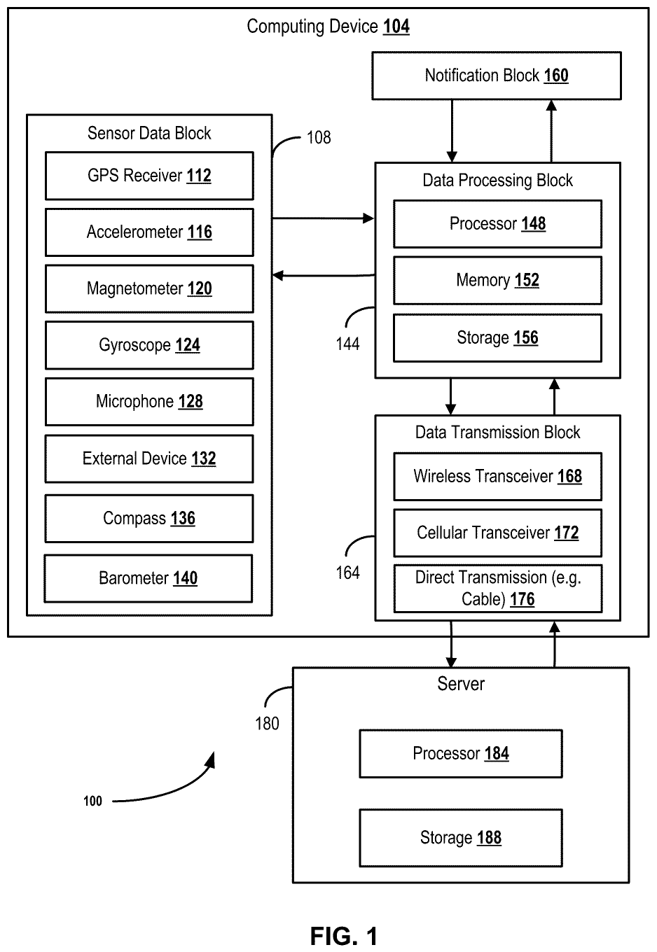

FIG. 1 is a system diagram illustrating a system 100 for detecting routes traveled by a vehicle according to some embodiments. System 100 includes a computing device 104 which includes a plurality of processing, sensor, and communication resource components. Computing device 104 may include a sensor data block 108, a data processing block 144, a data transmission block 164, and optionally a notification block 160. The sensor data block 108 includes data collection sensors as well as the data collected from sensors that is available to computing device 104. This can include external computing devices connected via Bluetooth, USB cable, or the like. Examples of external computing devices may include Internet of Things (IoT) devices, integrated vehicle sensors, dashcam devices, or other motion sensing devices. The data processing block 144 may include storage 156 which may include data from the sensors of the sensor data block 108 processed by processor 148. This may include, but is not limited to, analyzing, characterizing, manipulating, smoothing, subsampling, filtering, reformatting, etc. Examples of mobile devices include, but are not limited to, smartphones, tablets, laptops, application specific integrated circuits (ASICs), and the like.

Data transmission block 164 may process communications (e.g., transmitted and received communications), such as the processed sensor data transmitted to an external computing device (e.g., server 180). The external computing device may also store and/or process the data obtained from sensor data block 108. Server 180 may include its own processor 184 and storage 188.

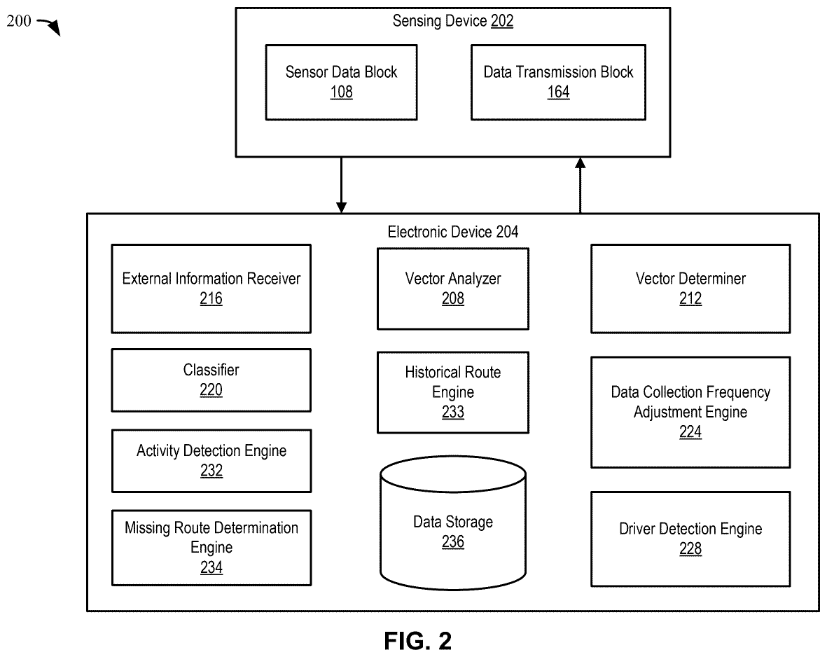

Notification block 160 may report the results of analysis of sensor data performed by the data processing block 144 to a user of the computing device 104 via a display (not shown). For example, notification block 160 may display or otherwise present a warning communication to a user of the computing device 104 upon determining that that the user may be a distracted driver. In some examples, the physical interaction determination may be a process executed by processor 148 of computing device 104. In other examples, the physical interaction determination may be a process executed by processor 184, as described further herein with respect to FIG. 2.

Some embodiments are described using examples where driving data is collected using computing device 104, also referred to as an electronic device or mobile device, and these examples are not limited to any particular electronic device. For example, computing devices may include a variety of devices that can be included within or connected to a mobile device. Examples of computing devices include, but are not limited to, devices with one or more of location determination systems such as global positioning system (GPS) receivers 112, accelerometers 116, magnetometers 120, gyroscopes 124, microphones 128, external (sensor) devices 132, compasses 136, barometers 140, communications capabilities, and the like. Exemplary electronic devices include smart watches, fitness monitors, Bluetooth headsets, tablets, laptop computers, smart phones, music players, movement analysis devices, and the like.

One or more sensors of computing device 104 (e.g., the sensors of sensor data block 108) may be operated to collect measurements to provide an indication as to physical interaction with the computing device 104. In some examples, the measurements may be collected at times when the electronic device is likely to be with a driver operating a vehicle, such as when the device is moving with a particular speed or when the device is located on a known road (e.g., a highway). The sensors used to collect data may be components of the computing device 104 and use power resources available to computing device 104 components (e.g., mobile device battery power and/or a data source external to mobile device 104).

In some examples, settings of a mobile device may be used to enable different functions described herein. For example, in Apple iOS, Android OS, and/or wearable device operating systems having certain settings enabled can enable certain functions of embodiments. In some examples, having location services enabled allows the collection of location information from the computing device (e.g., collected by global positioning system (GPS) receiver 112) and enabling the background app refresh allows some embodiments to execute in the background, collecting and analyzing driving data even when the application is not executing. In some instances, location information may be determined by other sensors of the mobile device, such as by tracking movement of the mobile device (e.g., using an accelerometer), by receiving location information from an external source, radio triangulation (e.g., using cellular, Bluetooth, or Wi-Fi radios), by an IP address of the mobile device, or by other means. Thus, in some embodiments, the measurements made using the one or more sensors of the computing device do not include GPS location data, but rely on sensors, such as an accelerometer, a gyroscope, or other sensor, that does not receive or utilize GPS location data. Thus, measurements made using the one or more sensors may be referred to in some embodiments as non-position data since, although position data can be derived from the measurements, the measurements include acceleration or velocity data, but not GPS location data. In some implementations, alerts are provided or surfaced using notification block 160 while the app is running in the background since the physical can be performed in the background.

FIG. 2 is a simplified block diagram illustrating an example of another system 200 for detecting routes traveled by a vehicle according to some aspects of the present invention. System 200 may include sensing device 202 and electronic device 204. Sensing device 202 may be the same or include similar components as computing device 104 described above. For example, and as illustrated, sensing device 202 may include sensor data block 108 and data transmission block 164. Sensing device 202 may be a standalone device configured solely as a data collection device for measuring, collecting, and transmitting data about its surroundings and/or motion to an external device, such as electronic device 204. Additionally, or alternatively, sensing device 202 may optionally include one or more data processing components. For example, one or more components of electronic device 204 may be incorporated within sensing device 202 (e.g., as specialized hardware or software). Electronic device 204 may include a separate device (or execute on a separate device) that communicates with the sensing device 202. For instance, as a separate device, electronic device 204 may be a mobile device (e.g., a smartphone, tablet, wearable device, or the like), a server, a computing device such as desktop or laptop computer, a specialized processing device (e.g., such as one or more application specific integrated circuits, field programmable gate arrays, or the like), a distributed processing system (e.g., such a cloud environment or the like), a combination thereof (e.g., as a distributed process), or the like.

In some embodiments, electronic device 204 may provide functionality using components including, but not limited to: a vector analyzer 208, a vector determiner 212, an external information receiver 216, a classifier 220 (e.g., a machine learning model), a data collection frequency adjustment engine 224, a driver detection engine 228, an activity detection engine 232, a historical route engine 233, and a missing route determination engine 234. Each component may include one or more processors (not shown) and memory (not shown). Instructions stored in the memory of a component may be executed by the one or more processors of the component provide the functionality of the component. Alternatively, one or more processors of electronic device 204 (not shown) may execute instructions stored in a central memory of electronic device 204 to provide the functionality of the components. The electronic device 204 may also include a data storage 236. In some instances, one or more of the components 208-234 operating on electronic device 204 may be stored in memory 152 or storage 156 of computing device 104, and/or executed by processor 148 of computing device 104.

One or more sensors of sensing device 202 (e.g., sensors of sensor data block 108) are used to measure characteristics of an environment in which sensing device 202 is positioned. For instance, the one or more sensors are used to collect characteristics of a vehicle while sensing device 202 is positioned in the vehicle during a drive. In that instance, the one or more sensors may be operated while sensing device 202 is positioned proximate to a driver during a time interval that corresponds to when the driver is operating the vehicle. Additionally, or alternatively, the one or more sensors may be temporarily or permanently installed within a vehicle to collect characteristics of the vehicle's movement during a drive any time motion is detected by the one or more sensors. As used herein, the terms “drive” and “trip” refer to the operation of a vehicle over an interval of time. Measurements obtained from the one or more sensors may be analyzed to determine acceleration vectors for the vehicle, as well as different features of the drive. In some instances, external data (e.g., weather, traffic, vehicle information, driver information) can be retrieved and correlated with collected driving data.

In some embodiments, a display of a mobile device (such as computing device 104) can show representations of driving data collected by the one or more sensors or generated by any of components 208-234. For instance, representations of driving data can be generated by transforming collected sensor data (e.g., driving data collected using sensor data block 108) into different results, including but not limited to, estimates of an activity of a user of sensing device 202 (e.g., whether the user is stationary, walking, running, or driving), estimates of the occurrence of different driving events during a drive or a trip for which data was collected, a metric descriptive of the driving behavior of a driver during the drive, a metric descriptive of the overall driving behavior of a driver for all drives, a metric descriptive of a driver's behavior as related to the occurrence of certain events, and/or a combination of transformed driving data and geographic data.

In some instances, collected driving data can be analyzed to assign scores to a drive, multiple drives, a driver, and/or driving behavior based on different criteria. A scoring engine (not shown) may aggregate data collected by the one or more sensors and apply one or more rules to generate scores for the embodiments. Further disclosure regarding scoring can be found in U.S. patent application Ser. No. 15/615,579, entitled “SYSTEMS AND METHODS FOR SCORING DRIVING TRIPS” (“the '579 application”), filed Jun. 6, 2017, herein incorporated by reference in its entirety.

Sensor data (e.g., collected using the sensor data block 108) may be used to analyze movement of sensing device 202 to detect the occurrence of driving events. The sensor data may be aggregated by electronic device 204 and analyzed once a predetermined amount of the sensor data is received. For example, once the electronic device 204 aggregates 50 megabytes of sensor data, the electronic device 204 may initiate an analysis of the sensor data. In another example, the electronic device 204 may initiate an analysis of the sensor data once electronic device 204 receives sensor data collected over a predetermined interval (e.g., a half hour of sensor data or an hour of sensor data). In still yet another example, the electronic device 204 aggregates sensor data associated with a trip and analyzes the sensor data once all of the sensor data associated with the trip is received. Alternatively, sensing device 202 includes one or more of components 208-234 and provides analysis of sensor data in real time (e.g., as the one or more sensors obtain measurements).

A GPS receiver may provide time stamped location and speed data that can be used by various applications executing on sensing device 202 and/or electronic device 204. The time stamped data can be used to accurately determine the location and speed of sensing device 202, which can be attributed to the location and speed of a vehicle. A GPS receiver may be used to detect a crash and determine a distance traveled by the vehicle after the detected crash. For instance, a GPS receiver may detect a crash by detecting sudden changes in speed or location. However, since sensing device 202 may operate with limited resources due to power and processing constraints and due to the high power consumption of operating a GPS receiver, sensing device 202 may use the one or more other sensors of sensor data block 108 to detect vehicle location and/or speed.

For instance, a sensing device positioned in a vehicle experiences mechanical vibrations related to the activity of the vehicle. These vibrations are measurable using a subset of the sensors in the sensor data block 108 of sensing device 202 referred to as an inertial measurement unit (IM). The measurements of the mechanical vibration can occur at varying amplitudes and frequencies, which can be used to identify the vehicle activity or in some cases activity of the user. For example, some or all of the accelerometer, gyroscope, and magnetometer measurements may distinguish walking patterns of the user from driving patterns of the vehicle (e.g., vehicle speed of approximately 5 m/s).

The IMU may include any of the accelerometer 116, the gyroscope 124, and the magnetometer 120. The IMU and the sensors included within may be a separate unit from a GPS receiver. The accelerometer 116 may be a three-axis accelerometer operable to measure longitudinal and lateral acceleration, as well as acceleration due to gravity. The gyroscope 124 and the magnetometer 120 may also be three-axis devices and may measure angular rotation and magnetic heading, respectively, in three dimensions. The IMU may combine the three-dimensional accelerometer data with the three-dimensional gyroscopic data to identify movement of the computing device with six degrees of freedom (6 DOF) (e.g., translation and rotation).

In some instances, data obtained from the IMU can be filtered and used as input to train a classifier, such as classifier 220, to predict vehicle speed. An example of such a classifier includes, but is not limited to, an XGBoost classifier. The classifier may be trained using features extracted from training data of a large number of driving trips. The extracted training features may include statistical features of the driving data, for example, median, variance, and maximum values of the IMU signals (e.g., accelerometer, gyroscope, and magnetometer signals). In some instances, the orientation of the computing device with respect to gravity may be determined and input to the classifier for training. Other statistical features may be used without departing from the scope of the present invention.

During a trip with sensing device 202 positioned in a vehicle, the IMU of sensing device 202 may be used to obtain movement measurements from any of the accelerometer, the gyroscope, and the magnetometer, and the movement measurements to generate an input for a classifier to predict vehicle speed. In some instances, the acceleration measurements used in the prediction of vehicle speed may be user acceleration measurements. User acceleration measurements may be acceleration measurements for which the gravity component of acceleration has been removed. In some instances, the acceleration measurements used in the prediction of vehicle speed may be raw acceleration measurements. Raw acceleration measurements may be acceleration measurements that include the gravity component.

The movement measurement signals from the IMU sensors may be sampled at a specified sampling rate to obtain digital signals. In some instances, a 9 Hz sampling rate may be used for the movement measurement signals. In other instances, a 30 Hz sampling rate may be used for the movement measurement signals. Other sampling rates, for example, 50 Hz or another sampling rate may be used. Higher sampling rates can provide improved speed estimation at the cost of increased resource consumption (e.g., processing and/or power resources). Electronic device 204 and/or sensing device 202 may modulate IM sensor sampling in real time to optimize the volume of data collected (e.g., for accuracy of data analysis) and the resource consumption.

For instance, if sensing device 202 is connected to a reliable power source (e.g., such as the vehicle's power supply), the movement measurement signals may be sampled at a highest frequency (e.g., 50 Hz or a predetermined highest frequency). If sensing device 202 is not connected to a power source, the movement measurement signals may be sampled at a lower frequency (e.g., 30 Hz sampling or a predetermined medium frequency). If the power supply of sensing device 202 is below a threshold value (e.g., 25% of a maximum battery capacity), then the sampling of the movement measurement signals may be reduced to a lower frequency (e.g., 9 Hz or a predetermined low frequency) to conserve the remaining power of sensing device 202. In some instances, the sampling rate of the movement measurement signals may be modified to improve the speed estimation. For instance, an accuracy metric may be used to indicate a likelihood that a given speed estimation is valid. If the accuracy metric does not exceed a threshold, the sampling rate of the movement measurement signals may be temporarily or permanently increased until the accuracy metric exceeds the threshold. Sensing device 202 may modulate the sampling rate in real time based on the operating conditions (e.g., resource consumption) of sensing device 202 or the metric.

Filtered IMU signals can distinguish driving, stopping, and user walking patterns. A bandpass filter (e.g., implemented in hardware or software), for example, an infinite impulse response (IIR) filter, may be used to filter the IMU signals to isolate frequencies indicative of various vehicle activities and to remove signal magnitude values exceeding a specified threshold. Portions of the signals having magnitude values exceeding the specified threshold may be excluded from further bandpass filtering. The digital bandpass filters can be designed to isolate the amount of vibration (i.e., frequencies) occurring within specific frequency ranges of interest. For example, the amount of vibrations may be separated into frequency ranges from 0.2 Hz to 1.1 Hz, from 1.1 Hz to 2.0 Hz, etc., depending on the sampling frequency, by bandpass filtering the signals.

Changes in lower frequency bands, for example up to approximately 1 Hz, may contain information about the vehicle stopping, while changes in higher frequency bands may correspond to the vehicle driving at higher speeds. The sources of the vibrations detected by the IMU sensors are complex interactions between engine vibrations resulting from speed changes or vibrations due to the vehicle interacting with the road surface at different speeds. A machine-learning model (e.g., the classifier) can learn these more complex interactions, which can be a combination of high and low frequencies, which correspond to each vehicle behavior.

In some instances, IM sensor signals having large magnitudes may be disruptive to the vehicle speed prediction. In those instances, filtering may exclude the large magnitude signals. For example, accelerometer signal magnitude values exceeding a threshold value of about 10 m/s² or another threshold value, as well as any subsequent portions of the signal, may be excluded. The portions of the IMU signals up to, but not including, the signal magnitude values exceeding the threshold value may be bandpass filtered using the IIR filter.

The IIR filtering process may employ forward-backward filtering in which the portions of the IMU signals are filtered normally (i.e., forward filtering), and the forward filtered signals are “flipped” in time and filtered again with the IIR filter (i.e., backward filtering) producing a squared amplitude response. The IIR filters can better isolate the signals of interest and minimize or eliminate nonlinear phase distortion of the signals. The IIR filters are applied recursively, such that the result of the last step of the filter algorithm is applied to the next step. IIR filtering methods may be more computationally efficient than filtering methods that require computation of all intermediate numerical quantities that lead to the result (e.g., Fourier transforms). IIR filters are also advantageous because they can isolate frequency ranges of interest with greater signal amplitude attenuation outside of a range of interest. In some implementations, a finite impulse response (FIR) filter, rather than an IIR filter, may be used for bandpass filtering of the IMU signals.

The number of frequency bands used for the bandpass filtering may be determined by the desired granularity and the sampling frequency of the sensor data. For example, 14 passbands may be used in equally spaced 0.3 Hz frequency bands from 0.2 Hz to a Nyquist sampling frequency of 4.5 Hz for data obtained using a 9 Hz sampling, and 28 passbands may be used from 0.2 Hz to 15 Hz for data obtained using a 30 Hz data. More granular frequency bands may be used when the IMU signals are sampled at higher sampling frequencies. Selection of the number and width of the frequency bands may be determined based on the desired signal quality in each band and the granularity of the information. For example, too many frequency bands can result in degraded signal quality due to the narrow bandwidth, while too few frequency bands may result in loss of granularity of the captured information.

Features, for example statistical features, may be extracted from some or all of the filtered signals. The features used as inputs to classifier 220 can be summary statistics (e.g., median, variance, and maximum) over the various signals, covering different time spans. The features may be extracted from time windows of different lengths. In some implementations, each of the statistical features may be extracted from the IMU signals over a 5-second time window, a 10-second time window, and a 20-second time window. Each window may be centered at the time point under consideration. Over each of the windows, summary statistics such as the mean, median, variance, maximum, and minimum of the various band-passed versions of the IMU sensor signals (e.g., accelerometer, gyroscope) contained in these windows can be calculated.

The different length windows may provide levels of stability for the feature values, with longer window times producing more stable feature values. Other window lengths or a different number of windows may be used without departing from the scope of the invention. For example, in some implementations, a single window may be used. For a bandpass filtered accelerometer signal between 0.2 Hz to 1.1 Hz, nine features may be extracted (e.g., median, variance, and maximum, with each feature extracted over a 5-second time window, a 10-second time window, and a 20-second time window). The feature extraction produces a single list of values (e.g., a feature vector) for each time point under consideration.

The extracted features (e.g., the feature vectors) may be input to the classifier. The machine learning model (e.g., the classifier) can then make a speed prediction based on the feature vector inputs. The vehicle speed prediction by the classifier may be quantized, for example, in increments of 5 m/s or another increment. In some implementations, the orientation of the sensing device with respect to gravity may be determined and input to the classifier.

Activity detection engine 232 identifies an activity that corresponds to sensor measurements received from the one or more sensors of sensor data block 108. For instance, the activity detection engine 232 identifies: when sensing device 202 is stationary, with a user who is walking, with a user who is running, with a user who is riding a bicycle, in a vehicle that is driving, in a vehicle that is flying, and the like. In some instances, activity detection engine 232 outputs a probability of the activity. In those instances, activity detection engine 232 may output more than one probability such as a 45% probability that sensing device 202 is with a user who is walking, a 33% probability that sensing device 202 is in a moving vehicle (e.g., with a user who is driving), and a 22% probability of some other activity. The probability may be expressed as an integer or real number, a percentage, a grade (such as a low, medium, or high), or in any way that represents the probability of a given activity.

Activity detection engine 232 may use the activity to detect drives from sensor data. For instance, activity detection engine 232 may analyze the data received from sensing device 202 and identify a first time when the activity indicates a high probability that sensing device 202 is in a car that is driving. Activity detection engine 232 may identify a second time after the first time in which there is a high probability another activity (e.g., stationary, walking). Activity detection engine 232 then defines a trip as occurring from the first time to the second time. Other components of electronic device 204 may then further analyze the sensor data received between the first time and the second time to identify driver behavior, driver score, crash detection, speed estimation, etc. In some instances, activity detection engine 232 or any of the operations described in connection with the activity detection engine 232 may be performed by an operating system to manage data collection by sensor data block 108.

In some instances, activity detection engine 232 may operate on sensing device 202 to control collection of measurements from sensor data block 108. Sensing device 202 may execute a data collection application that controls the operation of the one or more sensors of sensing device 202 (e.g., such as sampling rates and the like) and collects measurements from the one or more sensors. The data collection application can include one or more of the components 208-232. Since the sensing device 202 may operate with limited resources, the data collection application may be suspended or terminated by a user of sensing device 202, due to inactivity of the data collection application, when sensing device 202 is at rest, or the like. Activity detection engine 232 may operate in a background process to detect if a drive/trip is occurring. If a trip is occurring, activity detection engine 232 may cause the data collection application to be initiated and begin collection of sensor data associated with the drive.

In some instances, activity detection engine 232 may generate a geo-fence around sensing device 202, which, when crossed, will cause activity detection engine 232 to execute the data collection application or return the data collection application to an active state from a suspended state. If sensing device 202 crosses the geo-fence, then activity detection engine 232 may cause the data collection application to be initiated. For instance, the geo-fence may surround a user's vehicle or residence such that when the geo-fence is crossed, it is likely due to the user initiating a drive or a trip. The geo-fence may be generated after a period of inactivity such as when the sensing device has been at rest for a predetermined time interval. The geo-fence may be generated a predetermined distance from sensing device 202 such that when sensing device 202 crosses the geo-fence it is likely due to the beginning of a drive rather than through other activity such as walking. Activity detection engine 232 may use other mechanisms to determine whether to activate the data collection application including, but not limited to, detecting a visit (e.g., that the mobile device is at a particular location), a notification, a time interval, one or more sensor measurements exceeding threshold, or the like.

In some embodiments, sensing device 202 may not collect GPS data, as may be the case when sensing device 202 does not include a GPS receiver and/or when the data collection application of sensing device 202 does not collect GPS data and/or certain sensor measurements until it is executed (or returned to an actively executing state). As a result, accurate GPS data for a drive may be unavailable. For example, the data collection application may miss GPS data and sensor measurements associated with the portion of a trip that occurred prior to crossing the geo-fence. As a result, the data collection application may not collect GPS data and sensor measurements for the entire trip, thereby missing valuable information about the trip, driver behavior, potential vehicle collisions, etc. In some instances, sensing device 202 may not detect that a geo-fence has been crossed at all, thereby never activating the data collection application during the trip. In those instances, sensing device 202 may miss a particular route of a trip such that the data collection application does not collect certain sensor measurements or GPS data associated with the missed route. The data collection application may obtain some sensor measurements collected over the missed route from other processes executing on sensing device 202.

For instance, sensing device 202 may collect and cache some sensor measurements, such as accelerometer measurements, over a sliding window such as an immediately preceding time interval of a predetermined length. The sliding window may include the preceding, twenty-four hours, forty-eight hours, seventy-two hours, ninety-six hours, or any predetermined time interval. Applications of sensing device 202 and/or electronic device 204 may request and obtain sensor measurements for up to the length of the sliding window from the cache.

Historical route engine 233 may process GPS data collected during drives in a vehicle to construct historical routes taken within a road network. The GPS data may be collected by sensing device 202. Historical route engine 233 may use a combination of proximity analysis and logical consistency checks to align the GPS data collected by sensing device 202 with known road segments within the road network from map data for the road network. When a stream of GPS locations collected by sensing device 202 during a drive in a vehicle is received, historical route engine 233 may initiate a proximity analysis to identify the road segment that is closest to each GPS location. The proximity analysis may identify the road segment that is closest to each GPS location based on the known locations/coordinates of the road segment from the map data for the road network. This initial step ensures that each GPS data point is associated with the most probable road segment based on geographic proximity.

Recognizing that proximity alone may not always yield the most accurate results, historical route engine 233 may further incorporate logical consistency checks. Logical consistency checks may involve analyzing the sequence of identified road segments to ensure that they form a coherent and logical route, taking into account the connectivity and directional flow of the road network. For instance, if a sequence of GPS locations suggests a vehicle moved from one road segment to another, historical route engine 233 may evaluate whether such a transition is feasible within the existing road network. This involves verifying that there are no physical barriers, one-way restrictions, or other constraints that would make the transition improbable. By continuously comparing the distances between GPS locations and known road segments, and ensuring logical consistency throughout the route, the engine effectively filters out erroneous data points and constructs a reliable representation of the actual route taken.

After aligning the GPS data collected by sensing device 202 with known road segments within the road network from map data for the road network, historical route engine 233 may determine the actual route taken within the road network. For example, historical route engine 233 may construct a sequence of road segments traveled by the vehicle, including the distances traveled on each road segment, as well as the turns between adjacent road segments. Historical route engine 233 may identify a starting location and an ending location for each historical drive based on GPS data collected before and after each drive. For example, historical route engine 233 may determine that the most recent GPS location collected by sensing device 202 before a drive is the starting location of the drive, and the next GPS location collected after the drive is the ending location. Historical route engine 233 may store the actual route for a drive in a historical route datastore in association with the starting location, the ending location, or both. For example, historical route engine 233 may identify the actual route in the historical route datastore by the starting location, the ending location, or both. Identifying the actual route by the starting location, ending location, or both may enable other components of electronic device 204, such as missing route determination engine 234, to identify the actual route from the historical route datastore as a candidate route for a missed trip involving with a same starting location, ending location, or both, as described further herein. In some embodiments, the system stores actual routes determined from GNSS data collected during drives in a historical routes datastore. The GNSS data may be analyzed to identify a start location, an end location, and a sequence of turns and distances traveled by the vehicle. These actual routes may be indexed in the datastore based on their start and end locations, and may be subsequently retrieved and compared against estimated routes derived from motion sensor data during drives for which accurate GNSS data is unavailable. This enables the system to select candidate routes for comparison, including routes taken by the same vehicle or user during previous drives, as well as routes taken by other vehicles or users within the same road network.

Missing route determination engine 234 can determine a history of locations, one or more historical routes undertaken by sensing device 202, and those of the vehicle that carries sensing device 202, based on cached motion sensor measurements, such as accelerometer measurements. Missing route determination engine 234 can determine the history of locations and one or more historical routes for durations during a trip when, for various reasons, accurate GPS data is unavailable. For example, this may occur when the data collection application of sensing device 202 cannot collect GPS data (e.g., since the application is not yet executed, the mobile device does not cross a geo-fence, poor GPS reception, etc.), or otherwise does not collect good quality GPS data. As another example, this may occur when sensing device 202 does not include a GPS receiver and another GPS enabled sensing device was not present in the vehicle during the drive or was otherwise unable to collect accurate GPS data during the drive.

As to be described below, missing route determination engine 234 can determine a missing route start time based on, for example, a combination of outputs of activity detection engine 232 and motion sensor data. The start time of the missing route can also be the start time of a trip. Missing route determination engine 234 can also determine a missing route end time, which corresponds to the time when the data collection application starts collecting (or using) GPS data and or other sensor data to determine and track locations of the mobile device. Missing route determination engine 234 can fetch a subset of the cached motion sensor measurements, determine a sequence of turns and travelled path segments before and after the turns based on the motion sensor measurements, and construct an estimated route based on the sequence.

Missing route determination engine 234 may determine the starting and ending locations of a missing route based on, for example, available GPS data from before and after the missing route occurred. In some cases, the starting and ending locations may be determined from the starting and ending locations of other trips before and after the missed trip for which accurate GPS data was available. For example, given three successive trips for which cached motion sensor measurements are available, and where accurate GPS data is unavailable for the middle trip, the ending location of the first trip may be used as the starting location for the middle trip and the starting location for the last trip may be used as the ending location for the middle trip. The system may determine the start location of a drive by identifying the most recent GNSS location recorded by a GNSS enabled computing device prior to the beginning of the drive, such as the location after a trip immediately preceding the current drive and before the current drive began. Similarly, the end location may be determined by identifying the earliest GNSS location recorded after the drive has concluded and before a subsequent drive has begun. These locations may be used to associate the estimated route with specific geographic points, facilitating accurate route reconstruction and candidate route selection.

Missing route determination engine 234 can compare the estimated route with a set of candidate routes. In some embodiments, the set of candidate routes are generated from map data. For example, the set of candidate routes can represent a set of shortest alternative routes between the start point of the missing route and an end point of the missing route. Additionally, or alternatively, the set of candidate routes may be identified from historical routes identified by historical route engine 233. For example, the set of candidate routes can be identified from the plurality of historical routes that have matching starting and/or ending locations as the missing route.

Based on the comparison result between the estimated route and the set of candidate routes, missing route determination engine 234 can determine the missing route. In some examples, missing route determination engine 234 can provide the missing route together to the data collection application, which can combine the missing route with the routes determined based on GPS speed data, and display the combined routes as the complete trip in a map on computing device 104. Missing route determination engine 234 can also provide the missing route information to other components of electronic device 204 and/or sensing device 202 to determine various events (such as distracted driving events and vehicle crash events) in the missing route and generate outputs based on those events.

Although some embodiments are described in relation to the analysis of one or more turns made during a trip, it will be appreciated the motion data associated with one or more turns may be supplemented by motion data associated with one or more stops made during the trip. Thus, the discussion provided herein related to turns may be applied to one or more stops. Additionally, in some embodiments, the motion data associated with one or more turns made during the trip is replaced with motion data associated with one or more stops made during the trip. Thus, the discussion related to turns is applicable to stops. One of ordinary skill in the art would recognize many variations, modifications, and alternatives.

Applications of computing device 104 including at least some of components 208-234 may request data collection by the operating system while other applications of the computing device (such as the data collection application) are suspended or not executing. The operating system may collect sensor measurements over a predetermined time interval. For instance, an application may request sensor measurements from the operating system for up to 12 hours after the application is suspended or terminated. When the application is executed again, the application may request access to the sensor measurements collected by the operating system while the application was suspended or terminated, as well as the missing route information generated by missing route determination engine 234 for the route(s) that were undertaken during the time when the application was suspended or terminated. In some examples, the application may also include missing route determination engine 234 to determine the missing route based on the sensor measurements collected by the operating system.

As previously described, activity detection engine 232 may obtain the sensor measurements that were collected by the operating system (or another application) of the sensing device and generate a probability of an activity associated with the mobile device. Alternatively, this may be performed by the operating system itself. For instance, the operating system may output a probability that sensing device 202 is stationary, walking, running, driving, flying, or the like. Activity detection engine 232 may use the activity data from the operating system to determine a time interval during which a drive was likely to have occurred while the data collection application was suspended or terminated (e.g., not executing). Activity detection engine 232 may then request the sensor data collected by the operating system over the time interval. The sensor data collected by the operating system may be added to any sensor data collected by the data collection application.

For example, activity detection engine 232 may detect that sensing device 202 crossed a geo-fence and initiate execution of a data collection application to begin collection of sensor measurements such as IMU sensors. The data collection application then requests sensor data from the operating system for a time interval prior to when the mobile device crossed the geo-fence. This enables sensing device 202 to capture sensor measurements over the entire duration of the drive despite the application executing and beginning collecting of sensor measurements a few minutes into the drive.

In another example, when the data collection application is executed, the data collection application requests sensor data from the operating system of sensing device 202 over a time interval prior to execution of the data collection application. The data collection application identifies data of a first-time interval during which the operating system determines with a high probability that a drive occurred from the activity. The data collection application then requests the sensor data collected by the operating of the sensing device 202 over the first-time interval. In some instances, there may be a delay between when the drive begins and the operating system detects that a drive activity is occurring. Similarly, there may be delay between when the drive ends and the operating system detects that the drive ended. To ensure that sensor data for the entire trip is collected, the data collection application may request the sensor data over a second (larger) time interval that begins prior to the first-time interval (e.g., one minute, five minutes, ten minutes, or the like before the first time interval begins) and ends after the first-time interval (e.g., one minute, five minutes, ten minutes, or the like after the first-time interval ends).

### Example Application for Missing Route Determination

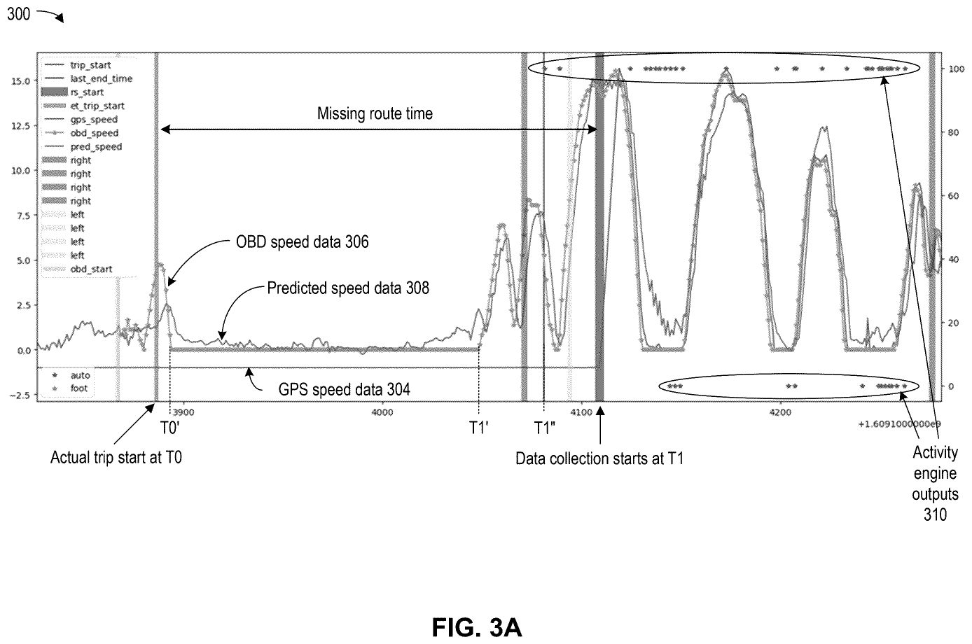

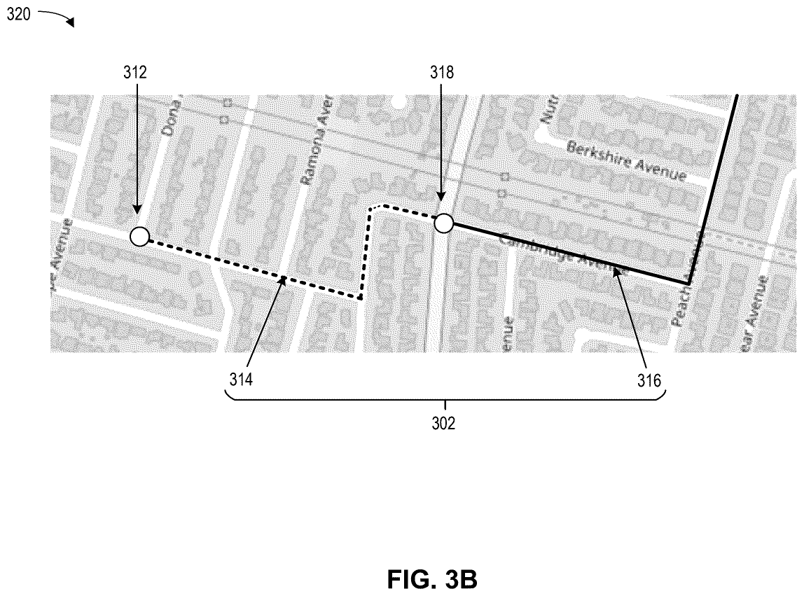

FIG. 3A and FIG. 3B illustrate an example application for missing route determination engine 234 to determine a missing route of a trip. In FIG. 3A, chart 300 illustrates time-series graphs of various motion data and event data from different sources during trip 302 undertaken by a user of a mobile device, such as a graph of GPS speed data 304, a graph of speed data 306 from on-board diagnostics (OBD), and a graph for predicted speed data 308, all with respect to time. Speed prediction can be based on accelerometer data, as well as other types of sensor data, as further described in U.S. patent application Ser. No. 18/500,457, entitled “METHOD AND SYSTEM FOR VEHICLE ROUTE DETERMINATION BASED ON MOTION DATA” (“the '457 application”), filed Nov. 2, 2023, the disclosure of which is herein incorporated by reference in its entirety.

Chart 300 further includes outputs 310 of activity detection engine 232. In chart 300, each dot of outputs 310 can represent the detection of a driving activity. FIG. 3B shows a map 320 of trip 302 of the vehicle that corresponds to the time-series motion data and event data of chart 300. In FIG. 3B, the trip starts at a location 312 and at time T0, and comprises a route 314 and a route 316. In FIG. 3B, route 314 can be a missing route of the trip where the GPS speed data is unavailable, or where the data collection application is in a suspended state. On the other hand, route 316 can be tracked and displayed by data collection application.

Referring back to FIG. 3A, the trip of the user starts at time T0, but the data collection application may start collecting GPS speed data 304 and generating location information starting at time T1, therefore GPS speed data 304 is flat before time T1. The GPS speed data allows route 316 of the user to be determined starting at time T1 and from location 318, but the trip actually starts at an earlier time T0. The data collection application may delay till time T1 to collect GPS data for various reasons. For example, activity detection engine 232 may be unable to detect a driving activity between times T0 and T1. The data collection application may be in a suspended state and wakes up at time T1 due to, for example, detection of a geo-fence, detection of a driving activity by activity detection engine 232, etc. As another example, the data collection application may be unable to collect GPS data due to poor GPS signal reception. If the locations of the mobile device (and the vehicle that carries the mobile device) are determined based solely on the GPS data, the location information may be missing for the duration between times T0 and T1. All these can lead to route 314 becoming a missing route in trip 302 reconstructed by the data collection application.

On the other hand, while the data collection application may be in a suspended state between times T0 and T1, the sensors may collect or generate speed data during that time, such as OBD speed data 306 and predicted speed data 308. Those data can be cached in a memory. Specifically, there can be fluctuations in OBD speed data 306 around time T0 due to, for example, the user being in another vehicle towards the end of a previous trip. OBD speed data 308 is flat and close to zero between times T0′ and T1′. OBD speed data 306 fluctuates again starting at time T1′ due to, for example, the user starting traveling in another vehicle at time T1′. On the other hand, fluctuating predicted speed data 308 can be captured between times T0 and T1. As to be described below, missing route determination engine 234 can determine, based on the cached measurement data, such as OBD speed data 306 and predicted speed data 308, the trip starts at time T0, select a subset of the cached measurement data collected between times T0 and T1, and determine missing route 314 based on the subset of the cached measurement data. Missing route determination engine 234 can then provide missing route 314 to the data collection application, which can then combine missing route 314 with route 316 to reconstruct trip 302.

### Example Components for Missing Route Determination Engine

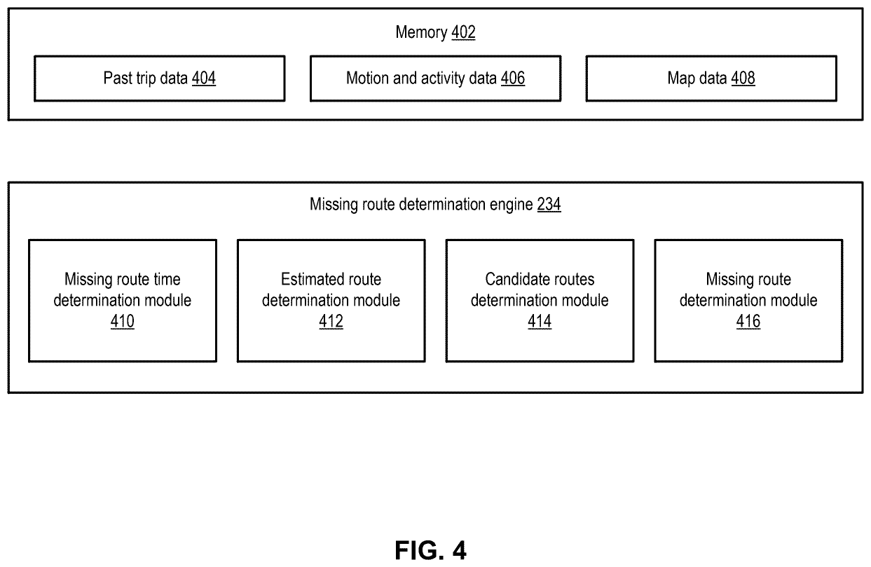

FIG. 4 illustrates examples of internal components of missing route determination engine 234. As shown in FIG. 4, missing route determination engine 234 can have access to a memory 402 that stores various data, including past trip data 404, motion and activity data 406, and map data 408. Missing route determination engine 234 can determine a missing route based the data stored in memory 402. Past trip data 404 can include a history of trips/routes undertaken by a vehicle/user, including trips undertaken by the user immediately before the current trip. Motion and activity data 406 can include cached sensor data, such as accelerometer data, speed data (e.g., OBD speed data 306), predicted speed data based on the cached sensor measurements (e.g., predicted speed data 308), etc., as well as the timestamps of the sensor data. Motion and activity data 406 can also include driving activities (e.g., driving activities shown in outputs 310 of activity engine) and their timestamps. Map data 408 can include map data of a locale in which the missing route is to be determined. The map data can include, for example, locations of thoroughfares (e.g., streets, highways, etc.), locations of road corners/turns, etc., that can be travelled by the vehicle/user during the trip.

Missing route determination engine 234 further includes a missing route time determination module 410, an estimated route determination module 412, a candidate routes determination module 414, and a missing route determination module 416. Missing route time determination module 410 can determine a start time of the trip, which can also be the start time of the missing route (e.g., time T0 in FIG. 3A). Missing route time determination module 410 can also determine an end time of the missing route, which can be the time when, for example, the data collection application wakes up and starts receiving GPS data or when location information from GPS data starts becoming available, etc., such as time T1 in FIG. 3A. Estimated route determination module 412 can then fetch a subset of motion and activity data 406 having timestamps between the start time and the end time of the missing route and construct an estimated route based on the subset of motion and activity data 406.

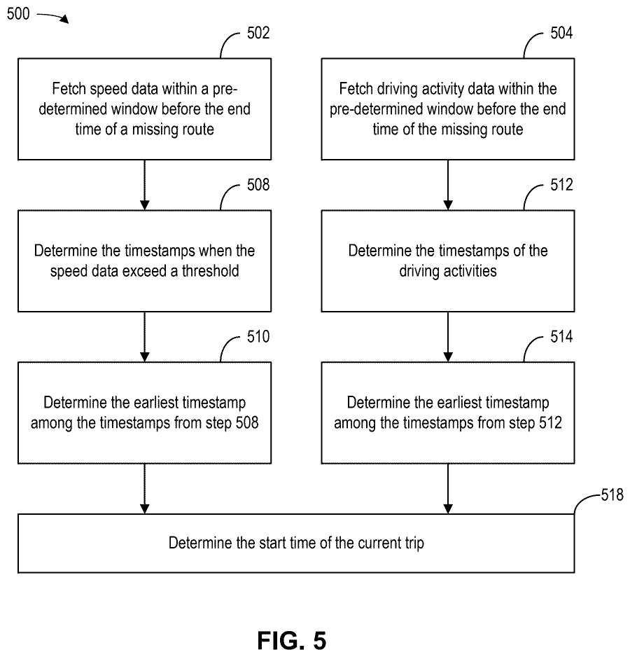

FIG. 5 illustrates an example flowchart of a method 500 performed by missing route time determination module 410 to determine the start time of a trip based on motion and activity data 406. Method 500 can start with steps 502 and 504. In step 502, missing route time determination module 410 can fetch speed data (e.g., OBD speed data 306, predicted speed data 308, etc.) within a pre-determined window before the end time of the missing route. The start of the pre-determined window can be based on, for example, detection of an event, such as a visit to a particular location, end of a previous trip, the start of the OBD, etc. A visit can be detected based on, for example, the location of the visit, an amount of time spent at the location, etc. The end of a trip can detected based on, for example, detecting a transition in the mode of transportation (e.g., from travelling in vehicle to walking, opening a car door, etc.). On the other hand, the end time can be the time when the data collection application wakes up and starts receiving GPS data, when location information from GPS data starts becoming available, etc. Referring to FIG. 3A, the pre-determined window can start at time T0.

Following step 502, missing route time determination module 410 can process the fetched speed data to identify timestamps when the speed exceeds a threshold, in step 504. The speed exceeding the threshold can indicate, for example, the user is driving in a vehicle. In step 510, missing route time determination module 410 can determine the earliest timestamp among the timestamps determined in step 508. The earliest timestamp can indicate, for example, when the user starts driving the vehicle. Referring back to FIG. 3A, from step 510, missing route time determination module 410 can determine the earliest timestamp when the speed data exceeds a threshold is at time T0.

In addition, in step 504, missing route time determination module 410 can fetch driving activity data within the pre-determined window before the end time of the missing route, followed by step 512, in which missing route time determination module 410 determines the timestamps of the driving activities, and step 514, in which missing route time determination module 410 determines the earliest timestamp among the timestamps of step 512. Referring to FIG. 3A, from step 514, missing route time determination module 410 can determine the earliest timestamp of the driving activities is at time T0.

Following steps 510 and 514, missing route time determination module 410 can determine the start time of the current trip based on the outputs of steps 510 and 514, in step 518. For example, missing route time determination module 410 can compare among the earliest timestamp of speed data that exceed the threshold, the earliest timestamp of driving activity, and the timestamps of the closet visit/end of trip, and determine the start time based on the earliest timestamp among these timestamps. Referring to FIG. 3A, missing route time determination module 410 can determine the earliest timestamps between timestamps T0 and T1 (time T0) and determine that the start time of the missing route is at time T0. In some examples, missing route time determination module 410 can also determine the start time based on a weighted average of the timestamps obtained from steps 510 and 514.

Based on the start time and the end time of missing route time determination module 410, estimated route determination module 412 can fetch a subset of motion data of motion and activity data 406 having timestamps between the start time and the end time of the missing route, and construct an estimated route based on the subset of motion data. The motion data can include accelerometer data, speed data, etc. From the motion data, estimated route determination module 412 can detect turns and their directions, as well as path segments between turns, and construct a representation (e.g., a graph) of a sequence of the turns and path segments.

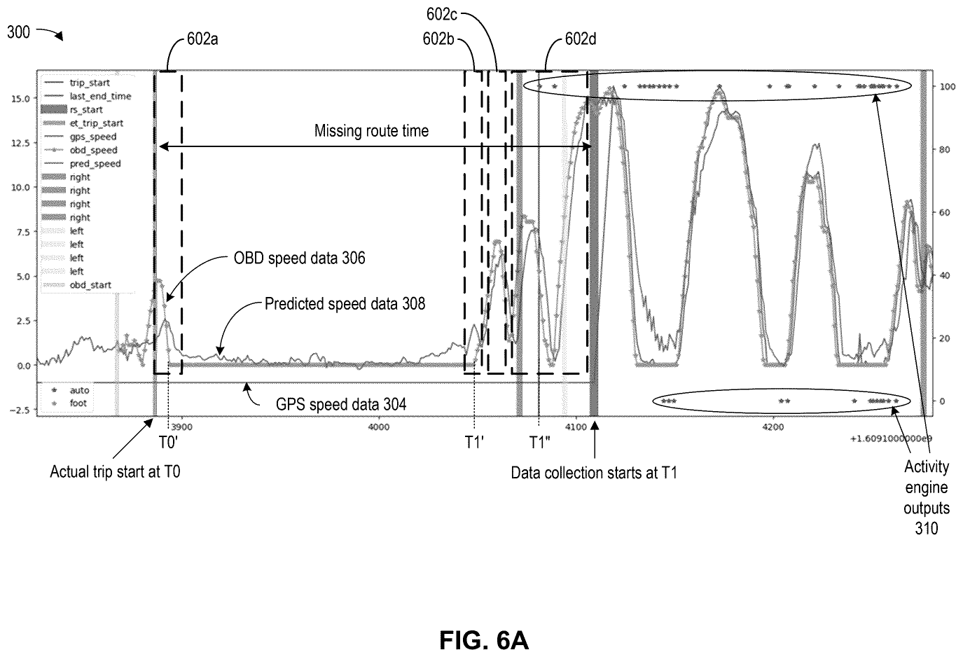

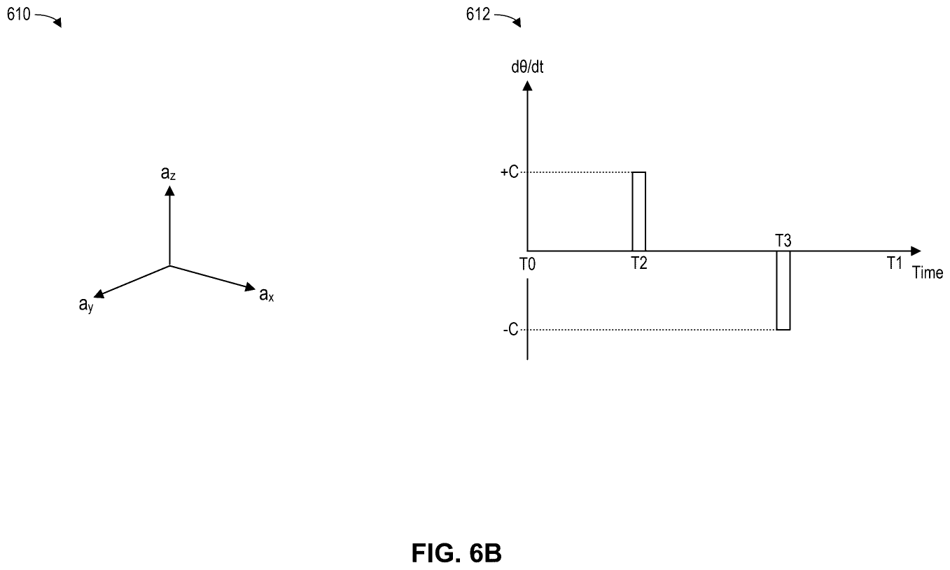

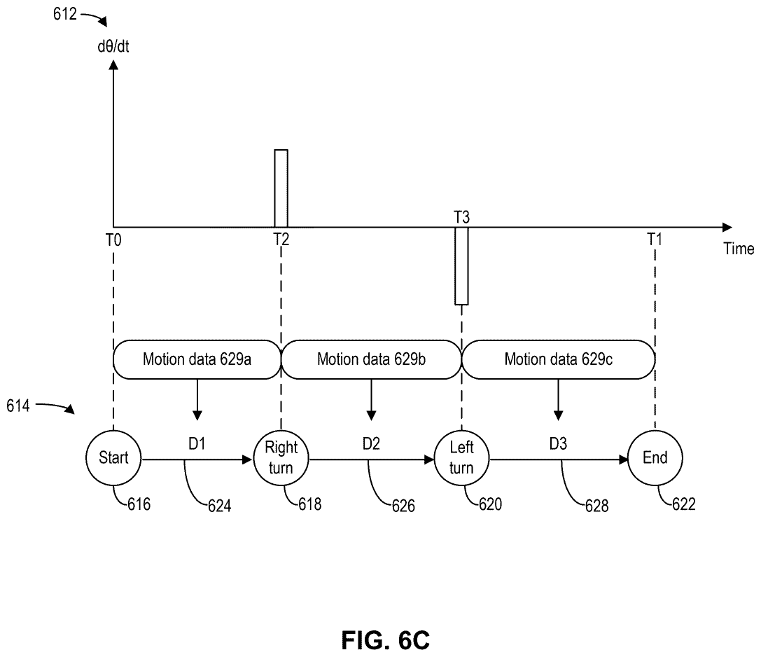

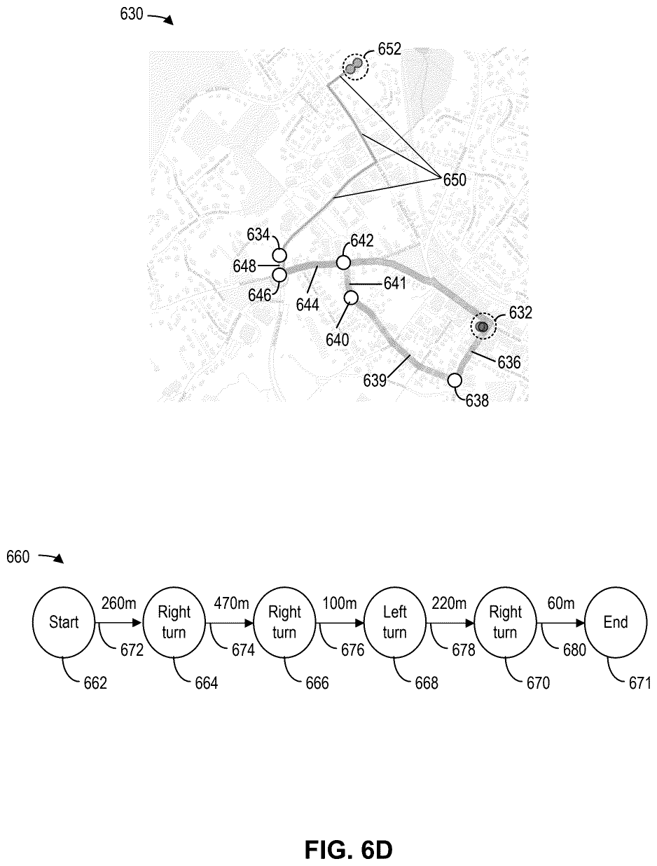

FIG. 6A, FIG. 6B, FIG. 6C, and FIG. 6D illustrate example operations of missing route determination engine 234. Referring to chart 300 of FIG. 3A (reproduced in FIG. 6A), estimated route determination module 412 can identify, based on the speed data between the start time (TO) and end time (T1) of the missing route, one or more segments that are likely to be data representing the user/vehicle in motion. The candidate segments can be identified based on, for example, the speed data (e.g., OBD speed data 306, predicted speed data 308, etc.) exceeding a threshold, activity engine outputs 310 indicating the user is driving a vehicle, etc. In FIG. 6A, estimated route determination module 412 can determine segments 602a, 602b, 602c, and 602d of speed data as likely to be data representing the user/vehicle in motion. In some examples, estimated route determination module 412 can merge multiple candidate segments into a single candidate segment based on, for example, the end time of one candidate segment and the start time of the next candidate segment being separated by a short time interval (e.g., 200 seconds). In a case where a missing driving route is to be determined, segments that are separated by a period of walking will not be merged.

Estimated route determination module 412 can then determine, for each candidate segment, turns and path segments between the turns. Referring to chart 610 on the left of FIG. 6B, motion and activity data 406 can include accelerometer data along multiple axes, such as along an x-axis (aₓ), a y-axis (a_{y}), and along a z-axis (a_{z}). Estimated route determination module 412 can determine a course rate of the user/vehicle based on accelerometer data aₓ, a_{y}, and a_{z}, and the L2 norm of each. In some examples, estimated route determination module 412 may use a neural network to process the accelerometer data and L2 norms to determine a course rate, using similar techniques as speed prediction as to be described below. Estimated route determination module 412 can determine the course rate with respect to time between the start time and the end time of the missing route. Referring to chart 612 on the right of FIG. 6B, estimated route determination module 412 can determine a rate of change of angle θ, which represents a rate of course change, with respect to time, and identify turns where the rate of change of angle θ exceeds a threshold. Comparing a rate of course change with a threshold can distinguish turns from lane changes. From chart 612, estimated route determination module 412 can identify a right turn at time T2 due to the rate of change of angle θ at time T2 having a value of +C whose magnitude exceeds a threshold and has a positive sign. Moreover, estimated route determination module 412 can identify a left turn at time T3 due to the rate of change of angle θ at time T3 having a value of −C whose magnitude also exceeds the threshold and has a negative sign.

Referring to FIG. 6C, after identifying the turns and their timestamps in the candidate segments, estimated route determination module 412 can construct a representation, which can be in the form of a directed graph 614 of a sequence of the turns and paths for the estimated route. In the example of FIG. 6C, a candidate segment spans from time T0 to time T1. As shown in FIG. 6C, directed graph 604 can include a plurality of nodes, including nodes 616, 618, 620, and 622, as well as edges 624, 626, and 628. Node 616 can represent a start point of the missing route, node 622 can represent an end point of the missing route, whereas node 618 and 620 can represent turns identified from chart 612. In addition, edges 624, 626, and 628 represent path segments travelled by the user/vehicle between nodes. For each edge between two nodes, estimated route determination module 412 can determine a distance based on a set of motion data between two time points associated with the two nodes. Estimated route determination module 412 can determine a distance based on, for example, performing an integration operation on a set of speed data over time or a double integration operation on a set of accelerometer data over time. For example, for edge 624, estimated route determination module 412 can fetch motion data 629a between times T0 and T2 (associated with start node 616 and right turn node 618), and determine a distance D1 based on performing one or more integrations on motion data 629a. Also, for edge 626, estimated route determination module 412 can fetch motion data 629b between times T2 and T3 (associated with right turn node 618 and left turn node 620), and determine a distance D2 based on performing one or more integrations on motion data 629b. Further, for edge 628, estimated route determination module 412 can fetch motion data 629b between times T3 and T1 (associated with left turn node 620 and end node 622), and determine a distance D3 based on performing one or more integrations on motion data 629c.

FIG. 6D illustrates a map of a missing route of a trip, as well as a linear graph corresponding to the missing route constructed by estimated route determination module 412. As shown in map 630, a trip starts at a start point 632 and ends at an end point 634, determined by missing route time determination module 410. Between start point 632 and end point 634 there is a path segment 636, followed by a right turn 638, a path segment 639, a right turn 640, a path segment 641, a left turn 642, a path segment 644, a right turn 646, and a path segment 648. After end point 634, the data collection application can receive GPS speed data and determine routes 650 of the trip, which ends at end point 652.

FIG. 6D further illustrates a directed graph 660 that corresponds to the missing route in map 630. Directed graph 660 includes nodes 662, 664, 666, 668, 670, and 671, as well as edges 672, 674, 676, 678, and 680. Node 662 corresponds to start point 632, node 664 corresponds to right turn 638, node 666 corresponds to right turn 640, node 668 corresponds to left turn 642, node 670 corresponds to right turn 646, whereas node 670 corresponds to end point 634. Further, edge 672 corresponds to path segment 636, edge 674 corresponds to path segment 639, edge 676 corresponds to path segment 641, edge 678 corresponds to path segment 644, whereas edge 680 corresponds to path segment 648. Estimated route determination module 412 can determine the distances of the path segments represented by the edges based on integrating the speed data and/or accelerometer data between the times represented by the nodes. In the example of FIG. 6C, estimated route determination module 412 can determine a distance of 260 meters for path segment 636 (represented by edge 672), a distance of 470 meters for path segment 639 (represented by edge 674), a distance of 100 meters for path segment 641 (represented by edge 676), a distance of 220 meters for path segment 644 (represented by edge 678), and a distance of 60 meters for path segment 648 (represented by edge 680).

After estimated route determination module 412 constructs an estimated route, missing route determination engine 234 can compare the estimated route with a set of candidate routes generated from map data 408. The set of candidate routes can be generated by candidate routes determination module 414 based on the map data. The set of candidate routes can represent a set of shortest alternative routes between the start point of the missing route and an end point of the missing route. Candidate routes determination module 414 can determine the location of start point 632, the missing route, based on an indication of an end of a previous trip, a visit, etc., from past trip data 404. Moreover, candidate routes determination module 414 can also determine the location of end point 634 based on, for example, GPS data received by the data collection application. Based on the map data including locations of thoroughfares (e.g., streets and highways), locations of road corners/turns, etc., that can be travelled by the vehicle/user during the trip, candidate routes determination module 414 can determine a set of shortest alternative routes that can be traveled by the user/vehicle between the locations of start point 632 and end point 634. Additionally, or alternatively, missing route determination engine 234 can compare the estimated route with a set of candidate routes from past trip data 404. The set of candidate routes may include actual routes detected from previous trips taken between the start point of the missing route and the end point of the missing route, as described above in relation to historical route engine 233.

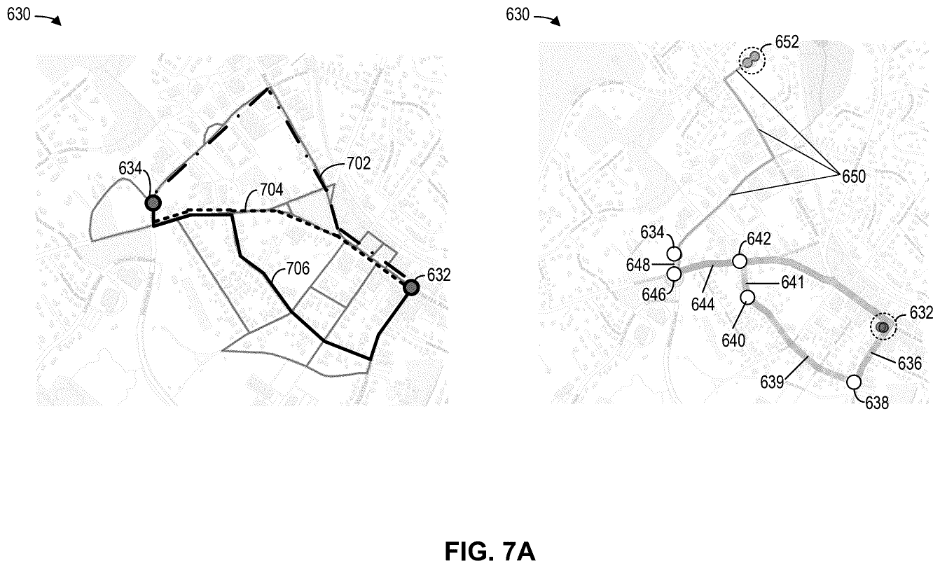

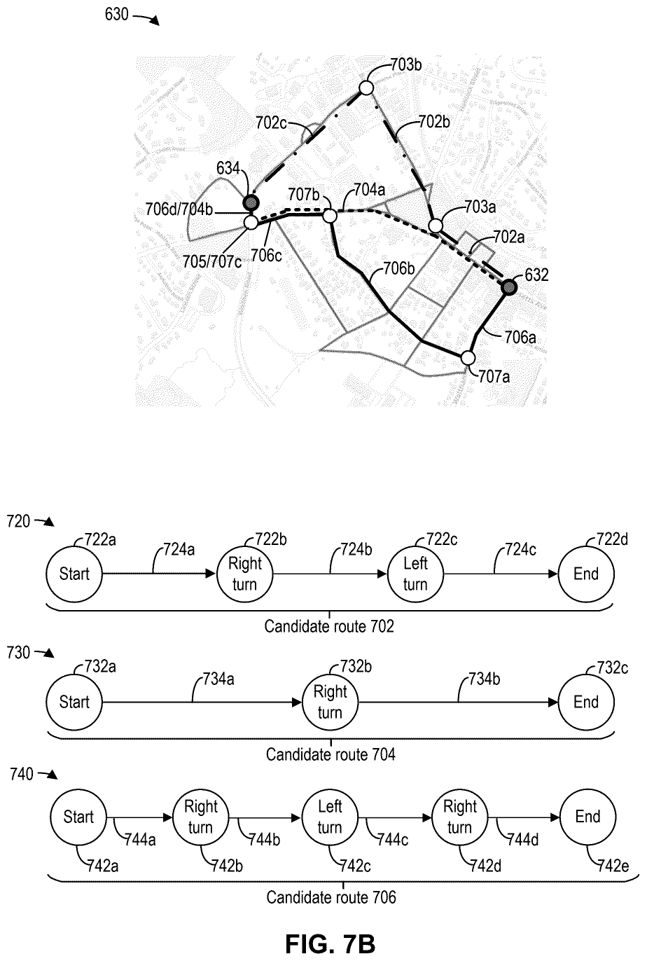

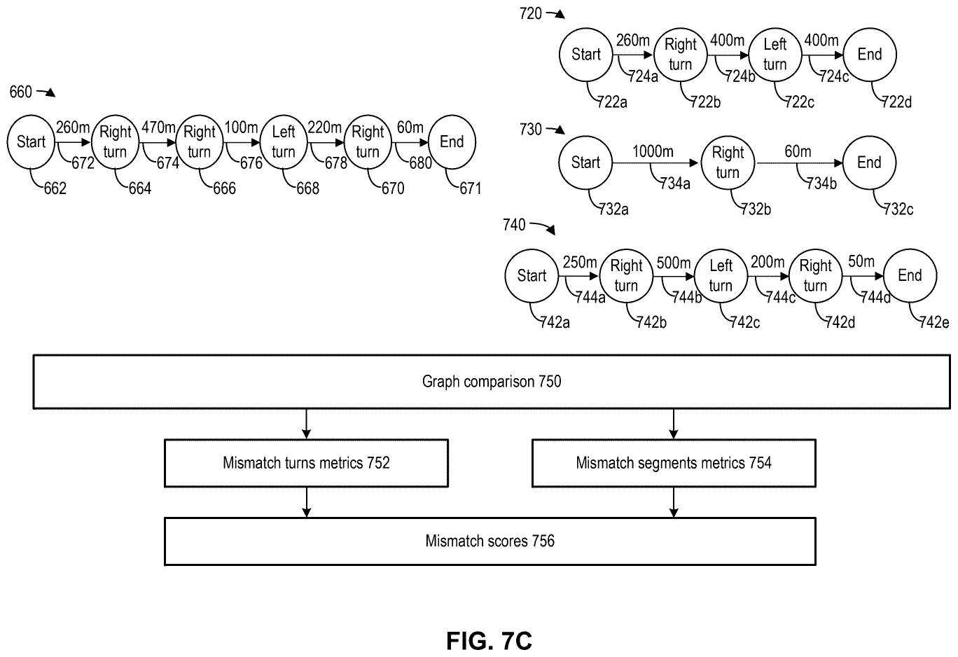

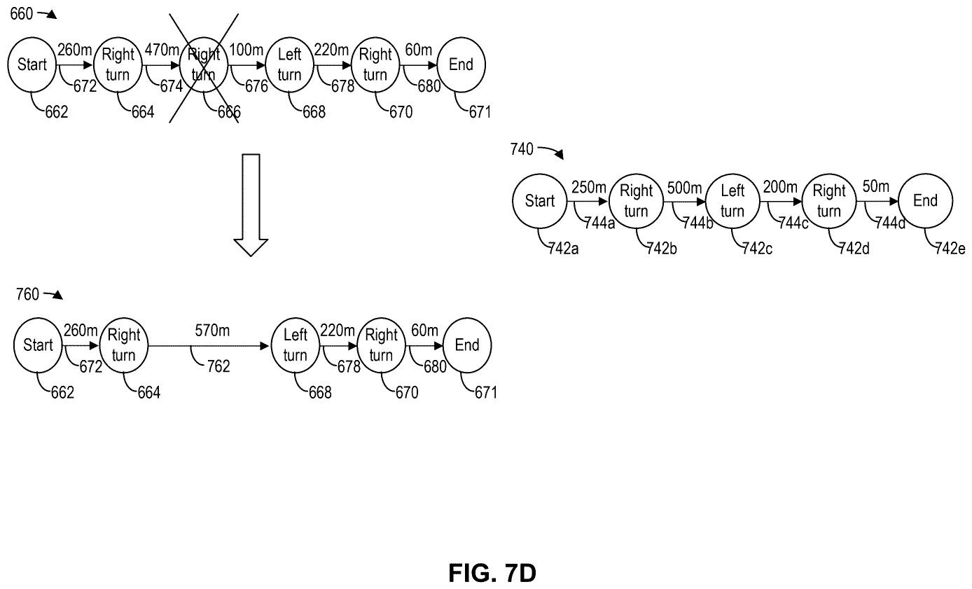

FIG. 7A and FIG. 7B illustrate examples candidate routes and their representations. As shown on the left of FIG. 7A, from map data of map 630 and/or actual routes from historical trips, candidate routes determination module 414 can determine a set of candidate routes between start point 632 and end point 634, including candidate routes 702, 704, and 706 which are each represented by different types of dotted lines. One of them can be selected as the route that has the closest matching to the missing route comprising path segments 636, 639, 641, 644, and 648 on the right.

FIG. 7B illustrates directed graph representations of candidate routes 702, 704, and 706. Each directed graph including nodes representing start, end, and turns, as well as edges representing path segments and their distances. As shown in FIG. 7B, candidate route 702 includes a path segment 702a, a right turn 703a, a path segment 702b, a left turn 703b, and a path segment 702c. Candidate route 702 can be represented by a directed graph 720 including a start node 722a representing start point 632, an edge 724a representing path segment 702a, a node 722b representing right turn 703a, an edge 724b representing path segment 702b, a node 722c representing left turn 703b, an edge 724c representing path segment 702c, and a node 722d representing end point 634. In addition, candidate route 704 includes a path segment 704a, a left turn 705, and a path segment 704b. Candidate route 704 can be represented by a directed graph 730 including a start node 732a, an edge 734a representing path segment 704a, a node 732b representing right turn 705, an edge 734b representing path segment 704b, and a node 732c representing end node 732c.

Further, candidate route 706 includes a path segment 706a, a right turn 707a, a path segment 706b, a left turn 707b, a path segment 706c, a right turn 707c, and a path segment 706d. Candidate route 706 can be represented by a directed graph 740 including a start node 742a, an edge 744a representing path segment 706a, a node 742b representing right turn 707a, an edge 744b representing path segment 706b, a node 742c representing left turn 707b, an edge 744c representing path segment 706c, a node 742d representing right turn 707c, and an edge 744d representing path segment 706d.

After directed graph 660 of the estimated route and the directed graphs 720, 730, and 740 of candidate routes are generated and/or identified, missing route determination module 416 can select one of candidate routes as the missing route based on a comparison between directed graph 660 and each of the directed graphs 720, 730, and 740. FIG. 7C and FIG. 7D illustrate examples of operations to select one of the candidate routes as the missing route. Referring to FIG. 7C, missing route determination module 416 can perform a graph comparison operation 750 between directed graph 660 and each of the directed graphs 720, 730, and 740 to determine, for example, mismatch turns metrics 752 and mismatch segment metrics 754, and compute a mismatch score 756 for each of directed graphs 720, 730, and 740 based on the mismatch turns metrics 752 and mismatch segments metrics 754 for each graph.

Specifically, to determine mismatch turns metrics 752, missing route determination module 416 can compare between the sequence of turns represented in directed graph 660 with the sequence of turns in each of the directed graphs 720, 730, and 740 and identify mismatch turns. For example, in FIG. 7C, directed graph 660 has a sequence of right turn, right turn, left turn, and right turn. Using the sequence of turns of directed graph 660 as a reference, missing route determination module 416 can determine that directed graph 720 has two missing right turns, directed graph 730 has two missing right turns and a missing left turns, whereas directed graph 740 has a missing right turn. Missing route determination module 416 can then determine mismatch turns metrics 752 for each of the directed graphs 720, 730, and 740 based on the number of missing/extra turns. For example, mismatch turns metrics 752 for directed graph 730 may have a higher value than mismatch turns metrics 752 for directed graph 720, which in turn have a higher value than mismatch turns metrics 752 for directed graph 740 due to directed graph 730 having a highest number of mismatch turns, followed by graph 720, with directed graph 740 having the minimum number of mismatch turns.

In addition, to determine mismatch segments metrics 754, missing route determination module 416 can determine a difference between a segment distance in directed graph 660 and the corresponding segment distance in each of the directed graphs 720, 730, and 740 and compute a metric based on the differences in the distances between pairs of path segments in the directed graphs. The corresponding segments can be based on, for example, an order of traversal of the edges. For example, between directed graph 660 and directed graph 720, the corresponding path segments are represented by a pair of edge 672 of directed graph 660 and edge 724a of graph 720, a pair of edge 674 of directed graph 660 and edge 724b of graph 720, and a pair of edge 676 of directed graph 660 and edge 724c of graph 720, and there is no corresponding path segments for edges 678 and 680 of directed graph 660 in graph 720. For each pair of edges, missing route determination module 416 can compute a square of the distance difference, and then sum the square of distance differences, to compute a segments mismatch metric between directed graphs 660 and 720 as follows:

$${Mismatch\_segments {\_metric}_{660 - 720} = {( 260 - 260 )}^{2} + 470 - 400 )}^{2} + {( 100 - 400 )}^{2} \qquad ( Equation 1 )$$

Missing route determination module 416 can also compute segment mismatch metrics based on corresponding path segments between directed graphs 660 and 730 and between directed graphs 660 and 740, as follows:

$$Mismatch\_segments {\_metric}_{660 - 730} = {( 260 - 1000 )}^{2} + {( 470 - 60 )}^{2} \qquad ( Equation 2 )$$

$$Mismatch\_segments {\_metric}_{660 - 740} = {( 260 - 250 )}^{2} + {( 470 - 500 )}^{2} + {( 100 - 200 )}^{2} + {( 220 - 50 )}^{2} \qquad ( Equation 3 )$$

Missing route determination module 416 can then compute a mismatch score 756 for each of directed graphs 720, 730, and 740 based on a combination of mismatch turns metrics 752 and mismatch segments metrics 754 for each directed graph. The combination can be based on, for example, a weighted average between the two metrics. Missing route determination module 416 can then rank the directed graphs based on the mismatch scores and select the directed graph, as well as the candidate route, having the lowest mismatch score, which can indicate that the candidate route is the closest match to the estimated route represented by directed graph 660.

FIG. 7D illustrates another example of mismatch score computation. As shown in FIG. 7D, prior to computing mismatch segments metrics 754, missing route determination module 416 can remove one or more turns represented in directed graph 660 of the estimated route to match with the sequence of turns represented in the directed graphs of the candidate routes. Such arrangements can reduce the effect of wrong or missing turns in the estimated route on finding the matching candidate route. Referring to FIG. 7D, missing route determination module 416 can remove right turn node 666 to generate a revised directed graph 760. In revised directed graph 760, edges 674 and 676 separated by the right turn node 666 can be merged into a single edge 762 and associated with a total distance of path segments represented by edges 674 and 676 (570 meters).

In FIG. 7D, missing route determination module 416 can compute mismatch turns metrics 752 for directed graph 740 based on counting a number of turns removed from directed graph 660 to match directed graph 740 (one). Moreover, for mismatch segments metrics 754, missing route determination module 416 can determine a sum of difference between distances of corresponding path segments between directed graphs 760 and 740. The corresponding path segments can be represented by a pair of edge 672 of directed graph 760 and edge 744a of directed graph 740, a pair of edge 762 of directed graph 760 and edge 744b of directed graph 740, a pair of edge 678 of directed graph 760 and edge 744c of directed graph 740, and a pair of edge 680 of directed graph 760 and edge 744d of directed graph 740. Mismatch segments metrics 754 for directed graph 740 (based on comparing with directed graph 760) can be computed based on the following Equation:

$$Mismatch\_segments {\_metric}_{660 - 740} = {( 260 - 250 )}^{2} + {( 570 - 500 )}^{2} + {( 220 - 220 )}^{2} + {( 60 - 50 )}^{2} \qquad ( Equation 4 )$$

Compared with Equation 3 above, the updated mismatch segments metrics 754 in Equation 4 can be reduced substantially due to removal of the extra right turn, which can improve the correspondence in the path segments between directed graphs representing the estimated route and the matching candidate route. Such arrangements can increase the likelihood of selecting candidate route 706 (represented by directed graph 740), as the missing route between start point 632 and end point 634.

In FIG. 7C and FIG. 7D, some of the candidate routes can be filtered prior to being provided for selection. For example, candidate routes for which mismatch turns metrics 752 and/or mismatch segments metrics 754 exceed pre-determined thresholds can be filtered out and not provided for selection. In addition, in some examples, the mismatch scores of some of the candidate routes can be adjusted down to favor their selection based on, for example, past trip data 404 indicating that user/vehicle has undertaken those candidate routes before.

### Example Applications Supported by Missing Route Determination Engine

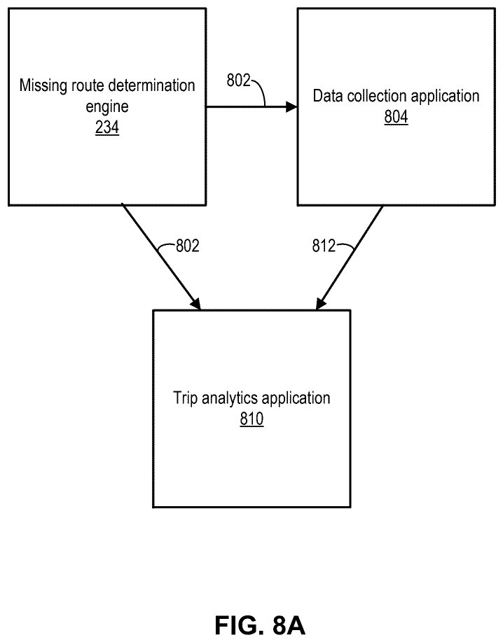

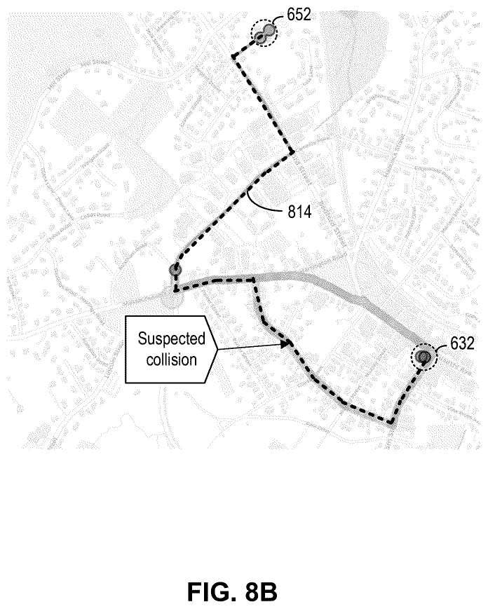

FIG. 8A and FIG. 8B illustrate examples of applications supported by missing route determination engine 234. As shown in FIG. 8A, missing route determination engine 234 can provide missing route information 802 to a data collection application 804, which can combine the missing route with the routes determined based on GPS speed data, and display the combined routes as the complete trip in a map on mobile device 104. Missing route determination engine 234 can also provide the missing route information to other components of electronic device 204 and/or mobile device 104, such as a trip analytics application 810. Trip analytics application 810 can determine various events, such as distracted driving events, vehicle crash events, etc., in from missing route information 802, as well as the rest of the routes 812, and generate outputs based on those events. For example, referring to FIG. 8B, trip analytics application 810 can detect that a vehicle crash event occurred at a part of trip 814 where the GPS speed data is not available based on the outputs of missing route determination engine 234.

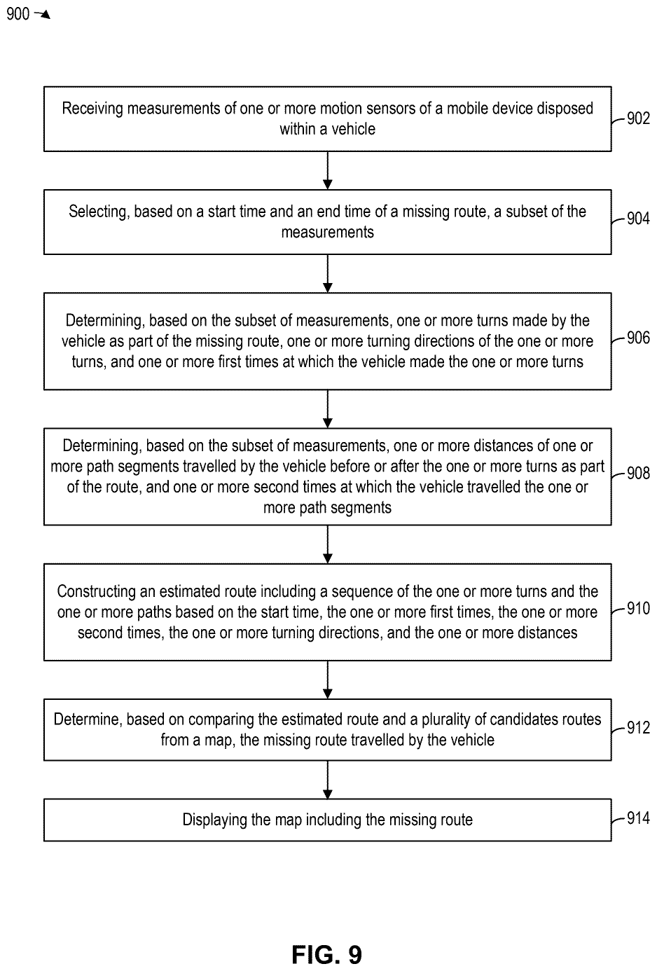

FIG. 9 is a flowchart illustrating an example of a method 900 for determining a missing route. Method 900 can be performed by, for example, missing route determination engine 234 of FIG. 4.

In block 902, missing route determination engine 234 may receive measurements of one or more motion sensors of a mobile device disposed with a vehicle (e.g., mobile device 104). The motion sensors may include, for example, accelerometers, speedometers, etc. The measurements can be cached in a memory and fetched by missing route determination engine 234. In some examples, missing route determination engine 234 can perform a speed prediction and determine the predicted speed of the user/vehicle with respect to time based on the accelerometer measurements.

In block 904, missing route determination engine 234 may select, based on a start time and an end time of a missing route, a subset of the measurements. As described above, missing route determination engine 234 can determine the end time of the missing route based on when the data collection application wakes up and starts receiving GPS data, when location information from GPS data starts becoming available, etc. Moreover, missing route determination engine 234 can use the detection of a prior visit or the end of a prior trip as a starting time and search for when the speed data first exceeds a threshold, or when the activity engine first outputs a signal indicating that the mobile device is in a vehicle. The earliest timestamp of when the speed data first exceeds the threshold and when the activity engine first outputs a signal indicating that the mobile device is in a vehicle can be used as a start time of the missing route. In some examples, missing route determination engine 234 may further filter the measurements to identify speed data for candidate segments where the speed data exceeds a threshold, to select the subset of the measurements, as described in FIG. 6A.

In block 906, missing route determination engine 234 can determine, based on the subset of measurements, one or more turns made by the vehicle as part of the missing route, one or more turning directions of the one or more turns, and one or more first times at which the vehicle made the one or more turns.

Referring to FIG. 6A, missing route determination engine 234 can determine a course rate of the user/vehicle based on accelerometer data aₓ, a_{y}, and a_{z}, and the L2 norm of each. In some examples, a neural network can be used to process the accelerometer data and L2 norms to determine a course rate, using similar techniques as speed prediction as to be described below. Missing route determination engine 234 can determine the course rate with respect to time between the start time and the end time of the missing route, and identify turns where the rate of change exceeds a threshold, as well as the timestamps at which the turns are made.

In block 908, missing route determination engine 234 can determine, based on the subset of measurements, one or more distances of one or more path segments travelled by the vehicle before or after the one or more turns as part of the route, and one or more second times at which the vehicle travelled the one or more path segments. Referring to FIG. 6B, missing route determination engine 234 can fetch motion data between timestamps of the turns, and perform integration operations on the motion data to compute the distance between the turns as the distance of a path segment. Missing route determination engine 234 can also determine the timestamps when the path segment is travelled by the user/vehicle.

In block 910, missing route determination engine 234 can construct an estimated route including a sequence of the one or more turns and the one or more paths based on the start time, the one or more first times of the turns, the one or more second times of the path segments, the one or more turning directions, and the one or more distances of the path segments.

Specifically, referring to FIG. 6B, the estimated route can be represented by a directed graph of a sequence of the turns and paths for the estimated route. The nodes of the directed graph can represent the start point, the end point, and the turns, whereas the edges can represent a path segment and is associated with a distance.

In block 912, missing route determination engine 234 can determine, based on comparing the estimated route and a plurality of candidate routes from a map, the route travelled by the vehicle.

Specifically, referring to FIG. 7A-FIG. 7D, the set of candidate routes can represent a set of shortest alternative routes between the start point of the missing route and an end point of the missing route from map data. The comparison can be based on a graph comparison operation and includes determining a number of missing turns, as well as distance mismatches between corresponding path segments of the estimated route and each of the set of candidate routes. The distance mismatch can be based on a sum of square of distance differences of corresponding path segments. In some examples, the estimated route graph can also be updated to remove or add extra turns to reduce the effect of extra/missing turns on determining the corresponding path segments and distance mismatches. The candidate route determined to have the best match (e.g., based on a minimum number of mismatch turns, a minimum distance mismatch, etc.) can be selected as the missing route.

In block 914, missing route determination engine 234 can provide the missing route for displaying. The missing route can be displayed, in a map, together with the rest of the trip for which the data collection application obtains GPS speed data to track the user/vehicle's location in the trip. In some examples, additional events (e.g., a vehicle collision) can be determined based on the motion data of the missing route and displayed in the map shown on the mobile device. The displaying of the map can be in a mobile device, or in a portal accessible by other people other than the user of the mobile device, such as a claim adjuster.

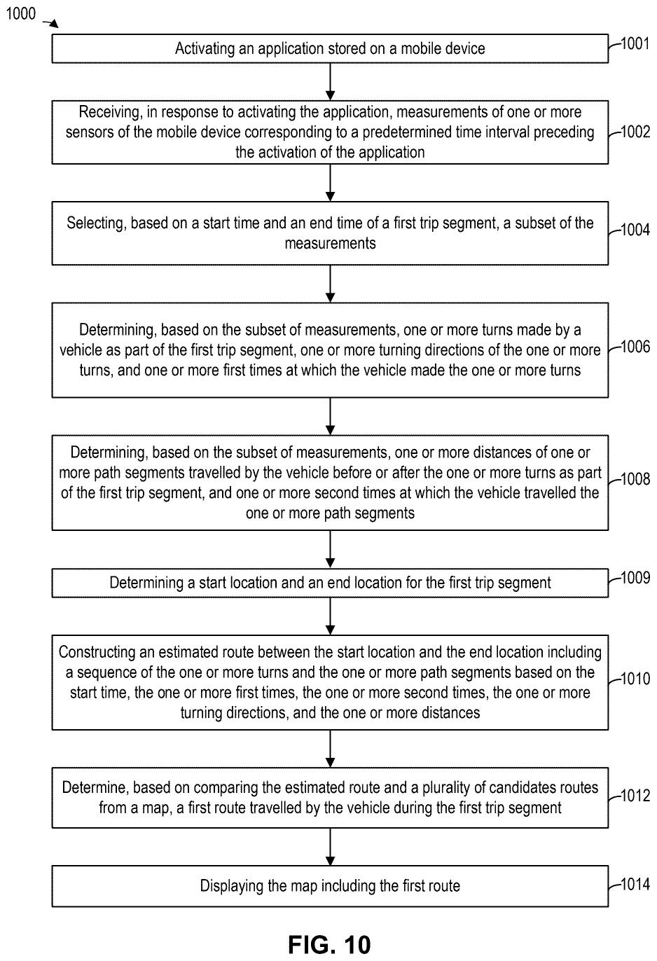

FIG. 10 is a flowchart of illustrating an example of a method 1000 for determining a missing route. Method 1000 can be performed by, for example, missing route determination engine 234 of FIG. 4.

In block 1001, an application stored on a mobile device can be activated. The application may be the same, or function in a similar manner, as the data collection application as described above. Activating the application can include executing the application or causing the application to return from a suspended state (e.g., threads of the application resume active execution). In some embodiments, the application is activated in response to the detection of a waking event. The waking event may be detected while the application is not executing (e.g., terminated or otherwise not loaded into memory) or is in a suspended state (e.g., process threads of the application are paused). In some instances, a background process of the application monitors events of the mobile device to detect the waking event. The background process may be the only portion of the application that may be executing. In other instances, the application registers with a monitoring application executing on the mobile device or the operating system of the mobile device to detect particular events when the application is not executing or is suspended.

The waking event may be any predetermined event detectable by the application, monitoring application, and/or operating system. For example, the application may generate a geo-fence that triggers the waking event when the geofence is crossed by the mobile device. A geo-fence may be a virtual perimeter of any size that surrounds the mobile device or any other point of interest. Other waking events can include, but are not limited to, detection that the mobile device is exceeding a speed threshold (e.g., a threshold that indicates the mobile device is positioned in a moving vehicle), expiration of a timer, a predetermined time, detection of a vibration exceeding a threshold, detection of a magnetometer value exceeding a threshold, receiving a notification, detecting proximity to a particular location or entity (e.g., a building, a residence, a particular location of a business such as a particular coffee shop, any location of the business such as any coffee shop owned by the business, a location of interest to a user associated with the mobile device, or the like), or the like.

If the waking event corresponds to the beginning of a drive (e.g., the geo-fence was crossed, sensor data indicates the mobile device is positioned in a moving vehicle, user input, or the like), the application begins collecting sensor data, such as inertial measurement sensor data from sensor data block 108 of FIG. 1, for the current drive. In some instances, the waking event may not be detected until after the drive starts. For instance, there may be delay between when the drive begins and when sufficient sensor data can be collected to indicate that the waking event has occurred. In those instances, the application may request sensor data collected and cached by the operating system over a previous time interval that preceded the waking event. The previous time interval may be included in a recorded time interval that was previously requested by the application.

For instance, the application may request sensor data for a ten minute time interval that immediately preceded the waking event. The application may request any sensor data collected during a time interval that immediately precedes the waking event. In some instances, the time interval may be dynamically selected (e.g., at the time in which the waking event is detected) based at least in part on sensor data received at or immediately after the waking event. For instance, if the sensor data indicates the vehicle has been driving for a while (e.g., is already driving at high speed, is already a predetermined distance from a starting point or the geo-fence, or the like), then the application may increase the length of the time interval to ensure the entire drive is captured. The length of the time interval may be dynamically determined using current sensor data and/or previous active or missed trips. For instance, previous trips may be used to determine if the application should increase the length of the time interval. The previous trips may be previous trips captured or detected by the mobile device or by other mobile devices. The other mobile devices may be similar mobile devices (e.g., being of a same class of devices, having a same operating system, having similar hardware, etc.). The application may continue to capture sensor data until it is determined that the drive has terminated (e.g., the sensor data indicates that the mobile device is not moving in a vehicle for a duration that exceeds a threshold).

In block 1002, measurements of one or more sensors of the mobile device corresponding to a predetermined time interval preceding the activation of the application are received in response to activating the application. In some embodiments, the measurements may be received by missing route determination engine 234 described above. The sensors may include, for example, accelerometers, speedometers, etc. The measurements can be cached in a memory and fetched by missing route determination engine 234. In some examples, missing route determination engine 234 can perform a speed prediction and determine the predicted speed of the user/vehicle with respect to time based on the accelerometer. In some embodiments, the measurements include activity data. Activity data can include, but is not limited to, an activity and a probability that the mobile device is involved in that activity, such as: stationary, walking (e.g., the mobile device is with a user who is walking), a low probability of automotive activity (e.g., a low probability that the mobile device is with a user that is driving), a medium probability of automotive activity (e.g., a medium probability that the mobile device is with a user who is driving), a high probability of automotive activity (e.g., a high probability that the mobile device is with a user that is driving), cycling (e.g., the mobile device is with a user that is cycling and therefore a low probability of automotive activity), and the like.

In block 1004, a subset of the measurements can be selected based on a start time and an end time of a first trip segment. In some embodiments, missing route determination engine 234 may select, based on the start time and an end time, a subset of the measurements. As described above, missing route determination engine 234 can determine the end time of the missing route based on when the data collection application wakes up and/or is activated and starts receiving GPS data, when location information from GPS data starts becoming available, etc. Moreover, missing route determination engine 234 can use the detection of a prior visit or the end of a prior trip as a starting time and search for when the speed data first exceeds a threshold, or when the activity engine first outputs a signal indicating that the mobile device is in a vehicle. The earliest timestamp of when the speed data first exceeds the threshold and/or when the activity engine first outputs a signal indicating that the mobile device is in a vehicle can be used as a start time of the missing route. In some examples, missing route determination engine 234 may further filter the measurements to identify speed data for candidate segments where the speed data exceeds a threshold, to select the subset of the measurements, as described in FIG. 6A.

As described above, a trip may refer to the operation of a vehicle over an interval of time. For example, a trip may include travel from an origin to a destination. The trip may be made up of multiple trip segments, such as the first trip segment. For example, the first trip segment may include travel from an origin to an intermediary location while a second trip segment includes travel from the intermediary location to the destination. In some embodiments, the first trip segment corresponds with a portion of the trip during which the application is not active on the mobile device. For example, the application may be in a suspended state during the first trip segment.

In block 1006, one or more turns made by a vehicle as part of the first trip segment, one or more turning directions of the one or more turns, and one or more first times at which the vehicle made the one or more turns can be determined based on the subset of measurements. In some embodiments, missing route determination engine 234 makes these determinations.

Referring to FIG. 6A, missing route determination engine 234 can determine a course rate of the user/vehicle based on accelerometer data aₓ, a_{y}, and a_{z}, and the L2 norm of each. In some examples, a neural network can be used to process the accelerometer data and L2 norms to determine a course rate, using similar techniques as speed prediction as to be described below. Missing route determination engine 234 can determine the course rate with respect to time between the start time and the end time of the missing route, and identify turns where the rate of change exceeds a threshold, as well as the timestamps at which the turns are made.

In block 1008, one or more distances of one or more path segments travelled by the vehicle before or after the one or more turns as part of the route, and one or more second times at which the vehicle travelled the one or more path segments can be determined based on the subset of measurements. In some embodiments, missing route determination engine 234 can determine the one or more distances of one or more path segments travelled by the vehicle before or after the one or more turns as part of the route, and one or more second times at which the vehicle travelled the one or more path segments. Referring to FIG. 6B, missing route determination engine 234 can fetch motion data between timestamps of the turns, and perform integration operations on the motion data to compute the distance between the turns as the distance of a path segment. Missing route determination engine 234 can also determine the timestamps when the path segment is travelled by the user/vehicle. For example, each path segment may start at a first time and end, after the vehicle traveled the determined distance, at a second time. The first time and the second time corresponding to the beginning and end of each path segment may correspond with the times at which the one or more turns are determined to have occurred.

In block 1009, a start location and an end location for the first trip segment can be determined. In some embodiments, missing route determination engine 234 can determine the start location and end location. In some embodiments, the start location is determined based on the end location of a previous trip. For example, after being activated, the application may retrieve a history of previous trips and identify an ending location from the most recent trip. The ending location may then be used as the start location for the first trip segment. Additionally, or alternatively, the application may access the most recently collected location information for the mobile device. The end location for the first trip segment may be determined based on the location of the mobile device upon activation of the application. For example, after activating the application, the application may begin collecting location measurements from a GPS sensor. The first location measurement may then be used as the end location of the first trip segment. Additionally, or alternatively, the end location for the first trip segment may be the current location of the mobile device. For example, after activating the application, it may be determined that a trip started and ended while the application was not active. After determining that the trip is no longer occurring and/or has recently ended, the current location of the mobile device may be used as the end location for the first trip segment.

In block 1010, an estimated route between the start location and the end location including a sequence of the one or more turns and the one or more path segments can be constructed based on the start time, the one or more first times, the one or more second times, the one or more turning directions, and the one or more distances. In some embodiments, missing route determination engine 234 can construct the estimated route. Specifically, referring to FIG. 6B, the estimated route can be represented by a directed graph of a sequence of the turns and paths for the estimated route. The nodes of the directed graph can represent the start point, the end point, and the turns, whereas the edges can represent a path segment and is associated with a distance.

In block 1012, a first route travelled by the vehicle during the first trip segment can be determined based on comparing the estimated route and a plurality of candidate routes from a map. In some embodiments, missing route determination engine 234 determines the first route travelled by the vehicle. Specifically, referring to FIG. 7A-FIG. 7D, the set of candidate routes can represent a set of shortest alternative routes between the start location and end location for the first trip segment from map data. The comparison can be based on a graph comparison operation and can include determining a number of missing turns, as well as distance mismatches between corresponding path segments of the estimated route and each of the set of candidate routes. The distance mismatch can be based on a sum of square of distance differences of corresponding path segments. In some examples, the estimated route graph can also be updated to remove or add extra turns to reduce the effect of extra/missing turns on determining the corresponding path segments and distance mismatches. The candidate route determined to have the best match (e.g., based on a minimum number of mismatch turns, a minimum distance mismatch, etc.) can be selected as the first route travelled by the vehicle during the first trip segment.

In block 1014, the map including the first route can be displayed. In some embodiments, missing route determination engine 234 provides the missing route for display. The first route can be displayed, in a map, together with the remainder of a trip for which the data collection application obtains GPS speed data to track the user/vehicle's location in the trip. In some examples, additional events (e.g., a vehicle collision) can be determined based on the motion data of the missing route and displayed in the map shown on the mobile device. The map can be displayed by the mobile device, or in a portal accessible by other people other than the user of the mobile device, such as a claims adjuster.

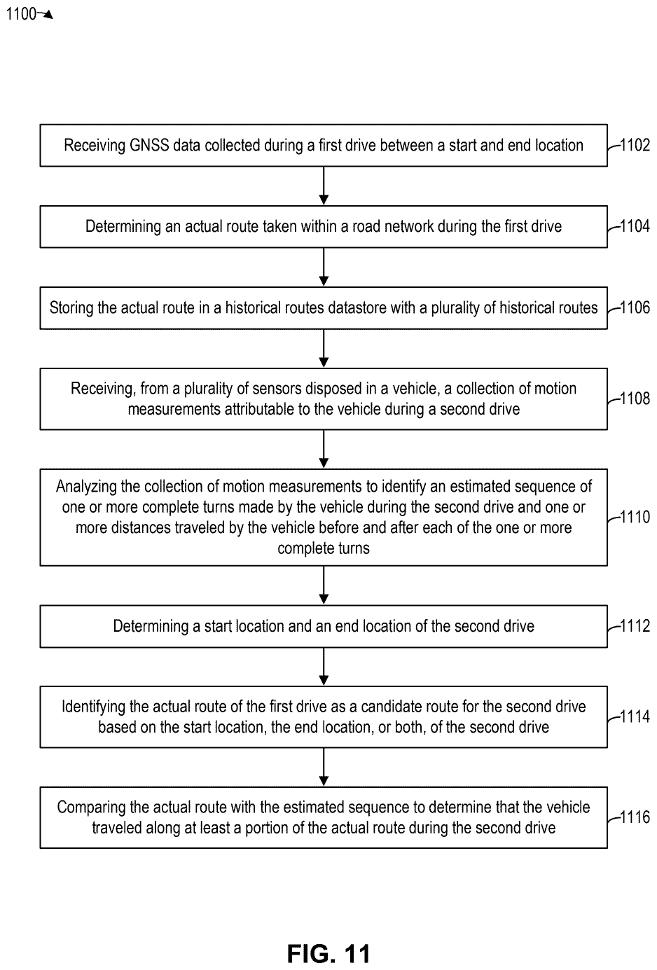

FIG. 11 is a flowchart illustrating an example of a method 1100 for determining a route taken by a vehicle during a drive. In block 1102, Global Navigation Satellite System (GNSS) data collected during a first drive between a start and end location is received. The GNSS data may include GPS data collected by a mobile device disposed in a vehicle. The GNSS data may indicate a plurality of locations of the mobile device during the first drive. While described as data collected during a first drive, the first drive may be any one of a plurality of drives involving a particular user and/or vehicle during which GNSS data was available and connected.

In block 1104, an actual route taken within a road network during the first drive is determined. The actual route may be determined by comparing the plurality of locations from the GNSS data with known locations of road segments within a road network from map data representing the road network, as described above in relation to historical route engine 233. The actual route may include a sequence of distances corresponding to the distance traveled on a road segment separated by turns made between different road segments.

In block 1106, the actual route is stored in a historical routes datastore with a plurality of historical routes. The plurality of historical routes may be determined from GNSS and/or GPS data collected by a same mobile device and/or one or more sensing devices associated with a user, user account, and/or vehicle for a corresponding plurality of historical drives. The plurality of historical routes in the historical routes datastore may be queried by their starting locations, their ending locations, and/or one or more mid-point locations.

In block 1108, a collection of motion measurements attributable to a vehicle during a second drive are received from a plurality of sensors disposed in the vehicle. The plurality of sensors may be integrated within the mobile device that collected the GNSS data for the initial drive and/or a separate sensing device. The plurality of sensors may be part of a sensing device temporarily or permanently installed in the vehicle. The plurality of motion sensors may include vehicle sensors and/or a sensing system integrated within a vehicle. The vehicle may be the same vehicle from the initial drive or a different vehicle. As described above, the motion measurements may be collected by one or more accelerometers, gyroscopes, magnetometers, or the like. Additionally, or alternatively, the motion measurements may be collected by one or more systems and/or sensors of the vehicle, such as a steering system, a speedometer, or the like. The collection of motion measurements may be received by the mobile device that collected the GNSS data and/or another processing system, such as a route detection server system. The collection of motion measurements may be received in response to a request for cached motion measurements. Additionally, or alternatively, the collection of motion measurements may be received as part of a prescheduled transmission by a sensing device. For example, the sensing device including the plurality of motion sensors may transmit collections of motion measurements at prescheduled intervals, after determining that a trip has just concluded, or the like. While described as a second drive, the collection of motion measurements attributable to the vehicle may be for a drive, or a portion thereof, that occurred before or after the first drive, and for which accurate GNSS data was not collected and/or is unavailable.

In block 1110, the collection of motion measurements are analyzed to identify an estimated sequence of one or more complete turns made by the vehicle during the second drive and one or more distances traveled by the vehicle before and after each of the one or more complete turns. As described above in reference to missing route determination engine 234, a course rate of the user/vehicle can be determined based on accelerometer data aₓ, a_{y}, and a_{z}, and the L2 norm of each. In some examples, a neural network can be used to process the accelerometer data and L2 norms to determine a course rate, using similar techniques as speed prediction as to be described below. The course rate with respect to time between the start time and the end time of the missing route can be determined, and turns where the rate of change exceeds a threshold, as well as the timestamps at which the turns are made, can be identified. Based on the collection of motion measurements, one or more distances of one or more path segments travelled by the vehicle before or after the one or more turns as part of the route, and one or more second times at which the vehicle travelled the one or more path segments can be determined. Integration operations on the motion measurements collected between timestamps of the turns can be used to compute the distance between the turns as the distance of a path segment. Timestamps when each path segment is travelled by the user/vehicle can also be determined from the motion data. The estimated sequence can then be constructed based on the start time, the one or more times of the turns and the one or more times of the path segments.

In block 1112, a start location and an end location of the second drive are determined. The start location may be the geographic location where the second drive began and/or the geographic location where the initial measurements of the collection of motion measurements were collected. The end location may be the geographic location where the second drive ended and/or the geographic location where the final measurements of the collection of motion measurements were collected. The start location and/or the end location may be approximate locations. For example, the start and end locations may encompass a geographic area or region within which the second drive is estimated to have started and/or ended.

The start and end locations may be determined from GPS data collected before and/or after the second drive took place. The GPS data may be collected by a mobile device associated with the vehicle, the plurality of sensors, a user, a user account, or the like. The GPS data may be associated with a drive that occurred directly before the second drive and/or a drive that occurred directly after the second drive. The start location of the second drive may be the end location of a prior drive. The end location of the prior drive may be used in response to determining that the prior drive was the most recent drive involving the same vehicle and/or same driver before the second drive. Likewise, the end location of the second drive may be the start location of the drive directly after the second drive involving the same vehicle and/or same driver. The start location may be determined from GPS data collected by a mobile device after the end of the prior drive and before the beginning of the second drive. The GPS data may be the most recent GPS data collected by a mobile device associated with the driver of the second drive. Likewise, the end location may be determined from the earliest GPS data collected by the mobile device after the second drive and before a next drive.

In block 1114, the actual route of the first drive is identified as a candidate route for the subsequent drive based on the start location of the second drive, the end location of the second drive, or both. The actual route may be identified and/or queried from a historical routes datastore along with additional routes for one or more drives, as described above in relation to FIGS. 7A-7B. Using the start location of the second drive, routes with the same or similar start location can be identified from the plurality of historical routes. Distances between the start location of the second drive and the start locations of historical drives can be determined. Historical routes where the distances are less than or equal to a predefined distance threshold can be identified as potential candidate routes. The predefined distance threshold may be 10 meters, 100 meters, 250 meters, or a similar distance that accounts for errors in GPS data, starting location estimations, variations in exact parking locations, or the like. A similar distance comparison between the end location of the second drive and the end locations of the potential candidate routes can be used to further filter the potential candidate routes from the historical routes to only those historical routes between the start and end location of the second drive. A similar process starting with the end locations and ending with the start locations can be used.

Because routes may be bi-directional, historical routes with the same or similar end location as the start location of the second drive, and the same or similar start location as the end location of the second drive may be identified as candidate routes for the second drive. Additional processing may be applied to such candidate routes to invert the sequence of turns and path segments for comparison with the estimated sequence of the second drive. In so doing, left turns in the candidate route may be converted to right turns, path segments where the travel direction is north may be converted to south, and the like.

Historical routes that pass through the start and end location of the second drive can be identified as candidate routes. Additional processing may be applied to such historical routes to remove turns and distances before the start location and/or after the end location of the second drive to produce a candidate route for comparison with the estimated sequence of distances and turns from the second drive.

In block 1116, the candidate route is compared with the estimated sequence to determine that the vehicle traveled along at least a portion of the candidate route during the second drive. As described above in relation to FIGS. 7C and 7D, the comparison can be based on a graph comparison operation and includes determining a number of missing turns, as well as distance mismatches between corresponding path segments of the estimated sequence and the candidate route. The distance mismatch can be based on a sum of square of distance differences of corresponding path segments. A match score for the candidate route can be generated based on the number of missing or mismatched turns and the distance mismatches. The match score may represent how closely the estimated sequence from the second drive aligns with the sequence from the candidate route. A determination that the vehicle traveled along at least a portion of the candidate route during the second drive may be made in response to determining that the match score for the candidate route meets one or more predefined threshold criteria.

Method 1100 may optionally include receiving, via an interactive GUI, a request to display the route traveled by the vehicle during the subsequent drive on a map and displaying the portion of the actual route on a map within the GUI in response to the request. The interactive GUI may be displayed via a mobile device, such as the mobile device that collected the GNSS data for the first drive.

In some instances, routes may be determined from previously collected data cached on a mobile device for later analysis and/or transmission. Further disclosure regarding the collection and transmission of data for use in route determinations can be found in U.S. patent application Ser. No. 17/379,682, entitled “METHODS AND SYSTEMS OF ACCESSING SENSOR-BASED DRIVING DATA” (“the '682 application”), filed Jul. 19, 2021, and U.S. patent application Ser. No. 17/505,353, entitled “METHOD AND SYSTEM FOR ACCESSING HISTORICAL SENSOR DATA WITHOUT LOCATION SERVICES” (“the '353 application”), filed Oct. 19, 2021, the disclosures of which are herein incorporated by reference in their entireties.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), mask programmable gate array (MPGA), processors, controllers, micro-controllers, microprocessors, other electronic units designed to perform the functions described above, and/or combinations thereof.

Also, it is noted that the embodiments and/or examples may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, one or more of the operations may be performed out-of-order from the order depicted. A process may terminate when its operations are completed or return to a previous step or block. A process could have additional steps or blocks not included in the figure. A process may correspond to a method, a function, a procedure, a subroutine, a subprogram, etc. When a process corresponds to a function, its termination corresponds to a return of the function to a calling function or a main function.

Furthermore, the devices and/or systems described herein may be implemented by hardware, software, scripting languages, firmware, middleware, microcode, hardware description languages, and/or any combination thereof. When implemented in software, firmware, middleware, scripting language, and/or microcode, the program code, or code segments to perform the necessary tasks may be stored in a non-transitory computer-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any non-transitory computer-readable medium tangibly embodying instructions may be used in implementing the methodologies described herein. For example, software codes may be stored in a memory. Memory may be implemented within the processor or external to the processor. As used herein, the term “memory” refers to any type of volatile, non-volatile, or other storage medium and is not to be limited to any particular type of memory, number of memories, or type of media upon which memory is stored.

Moreover, as disclosed herein, the term “storage medium” may represent one or more memories for storing data, including read only memory (ROM), random access memory (RAM), magnetic RAM, cache memory, magnetic disk storage mediums, optical storage mediums, flash memory devices, and/or other machine readable mediums for storing information. The term “computer-readable medium” includes, but is not limited to, portable or fixed storage devices, optical storage devices, and/or various other storage mediums capable of storing that contain or carry instruction(s) and/or data.

The examples and embodiments described herein are for illustrative purposes only. Various modifications or changes in light thereof will be apparent to persons skilled in the art. These are to be included within the spirit and purview of this application, and the scope of the appended claims, which follow.

What is claimed is:

1. A method of reconstructing a route taken by a vehicle from motion of the vehicle when accurate location data is unavailable, comprising:
collecting, by a mobile device disposed in a vehicle during a first drive, Global Navigation Satellite System (GNSS) data indicating a plurality of locations of the mobile device during the first drive;
analyzing, by a route detection server system, the GNSS data to identify a first start location and a first end location of the first drive;
comparing, by the route detection server system, the plurality of locations from the GNSS data with known locations of road segments within a road network from map data representing the road network to determine an actual route taken within the road network, wherein the actual route comprises a sequence of one or more turns separated by distances traveled along a road segment within the road network before and after each of the one or more turns;
storing, by the route detection server system, the actual route in a historical routes datastore with a plurality of historical routes detected from past GNSS data collected by the mobile device;
receiving, by the route detection server system, a collection of motion measurements collected by a plurality of motion sensors disposed in the vehicle during a subsequent drive for which accurate GNSS data from the mobile device is unavailable;
analyzing, by the route detection server system, the collection of motion measurements to identify an estimated sequence of one or more complete turns made by the vehicle during the subsequent drive and one or more distances traveled by the vehicle before and after each of the one or more turns;
determining, by the route detection server system, a subsequent start location of the subsequent drive based on a first location of the mobile device after a trip immediately preceding the subsequent trip and before the subsequent trip began;
determining, by the route detection server system, a subsequent end location of the subsequent drive based on a second location of the mobile device after the subsequent drive and before a next drive;
determining, by the route detection server system, a first distance between the first start location and the subsequent start location, a second distance between the first end location and the subsequent end location, or both the first distance and the second distance;
determining, by the route detection server system, that the first distance, the second distance, or both, are less than or equal to a predefined distance threshold;
identifying, by the route detection server system, the actual route as a candidate route for the subsequent drive from the plurality of historical routes in response to determining that the first distance, the second distance, or both, are less than or equal to a predefined distance threshold;
comparing, by the route detection server system, the sequence of one or more turns and distances within the road network from the actual route with the estimated sequence of one or more complete turns and distances during the subsequent drive to determine a mismatch score between the actual route and the estimated sequence;
determining, by the route detection server system, that the vehicle traveled along the actual route during the subsequent drive based on the mismatch score;
receiving, by the route detection server system, via an interactive graphical user interface (GUI) presented on a display of the mobile device, a request to display the subsequent drive on a map; and
causing, by the route detection server system, the interactive GUI to display the actual route on the map in response to the request.

2. A method comprising:
receiving a collection of motion measurements collected by a plurality of motion sensors disposed in a vehicle during a drive;
extracting, from the collection of motion measurements, an estimated sequence of one or more turns made by the vehicle during the drive and one or more distances traveled by the vehicle before and after each of the one or more complete turns;
determining a start location and an end location of the drive;
selecting one or more candidate routes between the start location and the end location from a plurality of historical routes, wherein each of the plurality of historical routes comprises a sequence of one or more turns separated by distances traveled along a road segment within a road network before and after each of the one or more turns;
comparing the sequence of one or more turns and distances within the road network from each of the one or more candidate routes with the estimated sequence of one or more turns and distances traveled by the vehicle during the drive to determine respective mismatch scores for each of the one or more candidate routes;
determining, based on the respective mismatch scores for each of the one or more candidate routes, that the vehicle traveled along a first route of the one or more candidate routes during the drive;
receiving, via an interactive graphical user interface (GUI) presented on a display of a mobile device, a request to display the drive on a map; and
causing the interactive GUI to display the first route on the map in response to the request.

3. The method of claim 2, wherein at least one of the plurality of historical routes is derived from Global Navigation Satellite System (GNSS) data collected by a GNSS enabled computing device during a first drive, and the method further comprises:
receiving the GNSS data from the GNSS enabled computing device, wherein the GNSS data indicates a plurality of locations of the computing device during the first drive;
analyzing the GNSS data to identify a first start location and a first end location of the first drive;
comparing the plurality of locations from the GNSS data with known locations of road segments within the road network from map data representing the road network to determine an actual route taken within the road network during the first drive; and
storing the actual route in a historical routes datastore.

4. The method of claim 2, further comprising:
receiving Global Navigation Satellite System (GNSS) data collected by a GNSS enabled computing device disposed in the vehicle during a previous drive that occurred directly before the drive; and
determining a most recent location of the GNSS enabled computing device leading up to a start time of the drive from the GNSS data, wherein the start location of the drive is determined based on the most recent location of the GNSS enabled computing.

5. The method of claim 2, further comprising:
receiving Global Navigation Satellite System (GNSS) data collected by a GNSS enabled computing device disposed in the vehicle during a subsequent drive that occurred directly after the drive; and
determining an earliest location of the GNSS enabled computing device after an end time of the drive from the GNSS data, wherein the end location of the drive is determined based on the earliest location of the GNSS enabled computing.

6. The method of claim 2, wherein a candidate route is selected as one of the one or more historical routes from the plurality of historical routes in response to:
determining that a first distance between the start location of the drive and a first location along the candidate route is less than a predefined threshold distance; and
determining that a second distance between the end location of the drive and a second location along the candidate route is less than the predefined threshold distance.

7. The method of claim 6, wherein the starting location of the candidate route is selected as the first location and the ending location of the candidate route is selected as the second location.

8. The method of claim 6, wherein the ending location of the candidate route is selected as the first location and the starting location of the candidate route is selected as the second location, and the method further comprises:
inverting the sequence of one or more turns and distances within the road network of the candidate route for comparison with the estimated sequence of one or more turns and distances traveled by the vehicle during the drive.

9. The method of claim 6, wherein the first location, the second location, or both, are intermediate locations along the candidate route between the starting location and the ending location of the candidate route, and the method further comprises:
removing, from the candidate route, turns and distances from the sequence of one or more turns and distances within the road network before the first location, after the second location, or both for comparison with the estimated sequence of one or more turns and distances traveled by the vehicle during the drive.

10. The method of claim 2, wherein the mismatch score for each of the one or more candidate routes is determined based on a sum of squared differences between corresponding distances traveled along segments of the estimated sequence and each candidate route, and a count of unmatched or extra turns.

11. The method of claim 2, wherein the collection of motion measurements comprise a subset of accelerometer measurements collected by an accelerometer of the plurality of motion sensors, and the method further comprises determining rates of course change with respect to time based on the subset of accelerometer measurements, wherein the one or more turns are extracted based on comparing the rates of course change against a threshold.

12. The method of claim 2, further comprising:
determining that a driving event involving the vehicle occurred at a first time during the drive based on the collection of motion measurements;
determining an estimated location of the driving event in relation to the estimated sequence of one or more turns and distances traveled by the vehicle during the drive;
identifying a first location along the first route that corresponds to the estimated location of the driving event; and
causing the interactive GUI to display, at the first location on the map, an indication of the detected driving event.

13. The method of claim 2, wherein the collection of motion measurements are received from the plurality of motion sensors by a Global Navigation Satellite System (GNSS) enabled computing device, and the start location and the end location of the drive are determined from GNSS data collected by the GNSS enabled computing device.

14. The method of claim 2, wherein the plurality of motion sensors are part of a sensing device installed in the vehicle.

15. A system comprising:
one or more sensors configured to measure movements of the one or more sensors while the one or more sensors are disposed in a vehicle during a drive; and
an electronic device comprising:
one or more processors; and
a memory storing a set of instructions;
wherein the one or more processors are configured to execute the set of instructions to:
receive electronic signals from the one or more sensors, the electronic signals indicating the movements measured by the one or more sensors during the drive;
extract, from the movements, an estimated sequence of one or more turns made by the vehicle during the drive and one or more distances traveled by the vehicle before and after each of the one or more complete turns;
determine a start location and an end location of the drive;
select one or more candidate routes between the start location and the end location from a plurality of historical routes, wherein each of the plurality of historical routes comprises a sequence of one or more turns separated by distances traveled along a road segment within a road network before and after each of the one or more turns;
compare the sequence of one or more turns and distances within the road network from each of the one or more candidate routes with the estimated sequence of one or more turns and distances traveled by the vehicle during the drive to determine respective mismatch scores for each of the one or more candidate routes;
determine, based on the respective mismatch scores for each of the one or more candidate routes, that the vehicle traveled along a first route of the one or more candidate routes during the drive;
receive, via an interactive graphical user interface (GUI) presented on a display of a mobile device, a request to display the drive on a map; and
cause the interactive GUI to display the first route on the map in response to the request.

16. The system of claim 15, wherein at least one of the plurality of historical routes is derived from Global Navigation Satellite System (GNSS) data collected by a GNSS enabled computing device during a first drive, and the one or more processors are further configured to execute the set of instructions to:
receive the GNSS data from the GNSS enabled computing device, wherein the GNSS data indicates a plurality of locations of the computing device during the first drive;
analyze the GNSS data to identify a first start location and a first end location of the first drive;
compare the plurality of locations from the GNSS data with known locations of road segments within the road network from map data representing the road network to determine an actual route taken within the road network during the first drive; and
store the actual route in a historical routes datastore.

17. The system of claim 15, wherein the one or more processors are further configured to execute the set of instructions to:
receive Global Navigation Satellite System (GNSS) data collected by a GNSS enabled computing device disposed in the vehicle during a previous drive that occurred directly before the drive; and
determine a most recent location of the GNSS enabled computing device leading up to a start time of the drive from the GNSS data, wherein the start location of the drive is determined based on the most recent location of the GNSS enabled computing device.

18. The system of claim 15, wherein the one or more processors are further configured to execute the set of instructions to:
receive Global Navigation Satellite System (GNSS) data collected by a GNSS enabled computing device disposed in the vehicle during a subsequent drive that occurred directly after the drive; and
determine an earliest location of the GNSS enabled computing device after an end time of the drive from the GNSS data, wherein the end location of the drive is determined based on the earliest location of the GNSS enabled computing device.

19. The system of claim 15, wherein a candidate route is selected as one of the one or more historical routes from the plurality of historical routes in response to:
determining that a first distance between the start location of the drive and a first location along the candidate route is less than a predefined threshold distance; and
determining that a second distance between the end location of the drive and a second location along the candidate route is less than the predefined threshold distance.

20. The system of claim 15, wherein the one or more processors are further configured to execute the set of instructions to:
determine that a driving event involving the vehicle occurred at a first time during the drive based on the electronic signals from the one or more sensors;
determine an estimated location of the driving event in relation to the estimated sequence of one or more turns and distances traveled by the vehicle during the drive;
identify a first location along the first route that corresponds to the estimated location of the driving event; and
cause the interactive GUI to display, at the first location on the map, an indication of the detected driving event.
